(19) United States
(12) Patent Application Publication
(10) Pub. No.: US 2014/0188990 A1
(43) Pub. Date: Jul. 3, 2014

(54) METHOD AND APPARATUS FOR ESTABLISHING USER GROUP NETWORK SESSIONS USING LOCATION PARAMETERS IN AN AUGMENTED REALITY DISPLAY

(71) Applicant: NOKIA CORPORATION, Espoo (FI)

(72) Inventor: Mark FULKS, Danville, CA (US)

(73) Assignee: NOKIA CORPORATION, Espoo (FI)

(21) Appl. No.: 13/728,266

(22) Filed: Dec. 27, 2012

(51) Int. Cl. H04L 29/06

(52) U.S. Cl. CPC H04L 65/403
USPC 709/204

(57) ABSTRACT

An approach is provided for causing a formation of at least one user group network session by a first device. Then, the network management platform causes a determination of a request from at least one second device for an access to the at least one user group network session. Subsequently, the network management platform causes determination of location information between the first device and the at least one second device based, at least in part, on physical proximity, a near field communication, a wireless network, or a combination thereof. Ultimately, the network management platform causes a granting of the access to the at least one second device to the user group network session based, at least in part, on the location information.

### BACKGROUND

Service providers and device manufacturers (e.g., wireless, cellular, etc.) are continually challenged to deliver value and convenience to consumers by, for example, providing compelling network services. With the expanding use of mobile devices, consumers' demand to have valuable services delivered to these devices has increased. Time and again, mobile device users desire to engage in group based interaction with other mobile device users. The overall quality of experience of a mobile device user as they engage with others in a collaborative networking environment depends on various factors. In particular, the extent to which the user's device can locate and connect the other devices and depict all content visually on a user interface. However, often user interfaces lack providing adequate information on a screen or usability for a user. As yet another factor, the persistent movement, placement or whereabouts of users relative to a defined network environment in which they interact impacts the quality of the experience. Further, the existing methods require various amounts of user involvement and levels of security, discouraging the users to access the group based interactions. Accordingly, service providers and device manufacturers face significant technical challenges to dynamically track a user's contacts using similar technology without navigating complex and multi-faceted problems related to data privacy and personal location disclosure permissions and providing rich content to augmented reality.

### SOME EXAMPLE EMBODIMENTS

Therefore, there is a need for an approach for causing a formation of at least one user group network session by a first device, and granting access to the at least one second device upon determining location information between the first device and the at least one second device based, at least in part, on physical proximity, a near field communication, a wireless network, or a combination thereof.

According to one embodiment, a method comprises causing, at least in part, a formation of at least one user group network session by a first device. The method also comprises determining a request from at least one second device for an access to the at least one user group network session. The method further comprises determining location information between the first device and the at least one second device based, at least in part, on physical proximity, a near field communication, a wireless network, or a combination thereof. The method further comprises causing, at least in part, a granting of the access to the at least one second device to the user group network session based, at least in part, on the location information.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a formation of at least one user group network session by a first device. The apparatus is also caused to determine a request from at least one second device for an access to the at least one user group network session. The apparatus is further caused to determine location information between the first device and the at least one second device based, at least in part, on physical proximity, a near field communication, a wireless network, or a combination thereof. The apparatus further causes, at least in part, a granting of the access to the at least one second device to the user group network session based, at least in part, on the location information.

According to another embodiment, a computer-readable storage medium carries one or more sequences of one or more instructions which, when executed by one or more processors, cause, at least in part, an apparatus to cause, at least in part, a formation of at least one user group network session by a first device. The apparatus is also caused to determine a request from at least one second device for an access to the at least one user group network session. The apparatus is further caused to determine location information between the first device and the at least one second device based, at least in part, on physical proximity, a near field communication, a wireless network, or a combination thereof. The apparatus further causes, at least in part, a granting of the access to the at least one second device to the user group network session based, at least in part, on the location information.

According to another embodiment, an apparatus comprises means for causing, at least in part, a formation of at least one user group network session by a first device. The apparatus also comprises means for determining a request from at least one second device for an access to the at least one user group network session. The apparatus further comprises means for determining location information between the first device and the at least one second device based, at least in part, on physical proximity, a near field communication, a wireless network, or a combination thereof. The apparatus further comprises means for causing, at least in part, a granting of the access to the at least one second device to the user group network session based, at least in part, on the location information.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of causing a formation of at least one user group network session by a first device, and granting access to the at least one second device upon determining location information between the first device and the at least one second device based, at least in part, on physical proximity, a near field communication, a wireless network, or a combination thereof, according to one embodiment;

FIG. 2 is a diagram of the components of user equipment (UE) 101, according to one embodiment;

FIG. 3 is a diagram of the components of network management platform 111, according to one embodiment;

FIG. 4 is a diagram of the components of data source retrieval module 301, according to one embodiment;

FIG. 5 is a flowchart of a process for causing a formation of at least one user group network session by a first device, and granting access to the at least one second device upon determining location information between the first device and the at least one second device based, at least in part, on physical proximity, a near field communication, a wireless network, or a combination thereof, according to one embodiment.

FIG. 6 is a flowchart of a process for granting access to the at least one user group on an invitation from the first device to the second device, and presenting the user group network session in an augmented reality user interface. The flowchart further provides a process for monitoring the location information and determining to maintain access to the user group network session based, at least in part, on the monitoring, according to one embodiment.

FIG. 7 is a flowchart of a process for causing a ranking of the at least one second device based, at least in part, on a physical proximity and/or social proximity to the first device and further causing a marking and/or broadcasting of the one or more places by the first device and/or the at least one second device, according to one embodiment.

FIG. 8 is a flowchart of a process for causing a presentation of an alert message on determining that at least one second device has exited the user group network session. The flowchart further provides a process for termination of the at least one user group network session by the first device any time after the creation of the at least one user group network session, according to one embodiment.

FIG. 9 is a diagram of user interface utilized in the processes of FIGS. 5-8, according to various embodiments;

FIG. 10 is a diagram of user interface utilized in the processes of FIGS. 5-8, according to various embodiments;

FIG. 11 is a diagram of user interface utilized in the processes of FIGS. 5-8, according to various embodiments;

FIGS. 12A-12J are diagrams of user interfaces utilized in the processes of FIG. 5-8, according to various embodiments;

FIG. 13 is a diagram of hardware that can be used to implement an embodiment of the invention;

FIG. 14 is a diagram of a chip set that can be used to implement an embodiment of the invention; and

FIG. 15 is a diagram of a mobile terminal (e.g., handset) that can be used to implement an embodiment of the invention.

### DESCRIPTION OF SOME EMBODIMENTS

Examples of a method, apparatus, and computer program for causing a formation of at least one user group network session by a first device, and granting access to the at least one second device upon determining location information between the first device and the at least one second device based, at least in part, on physical proximity, a near field communication, a wireless network, or a combination thereof, are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

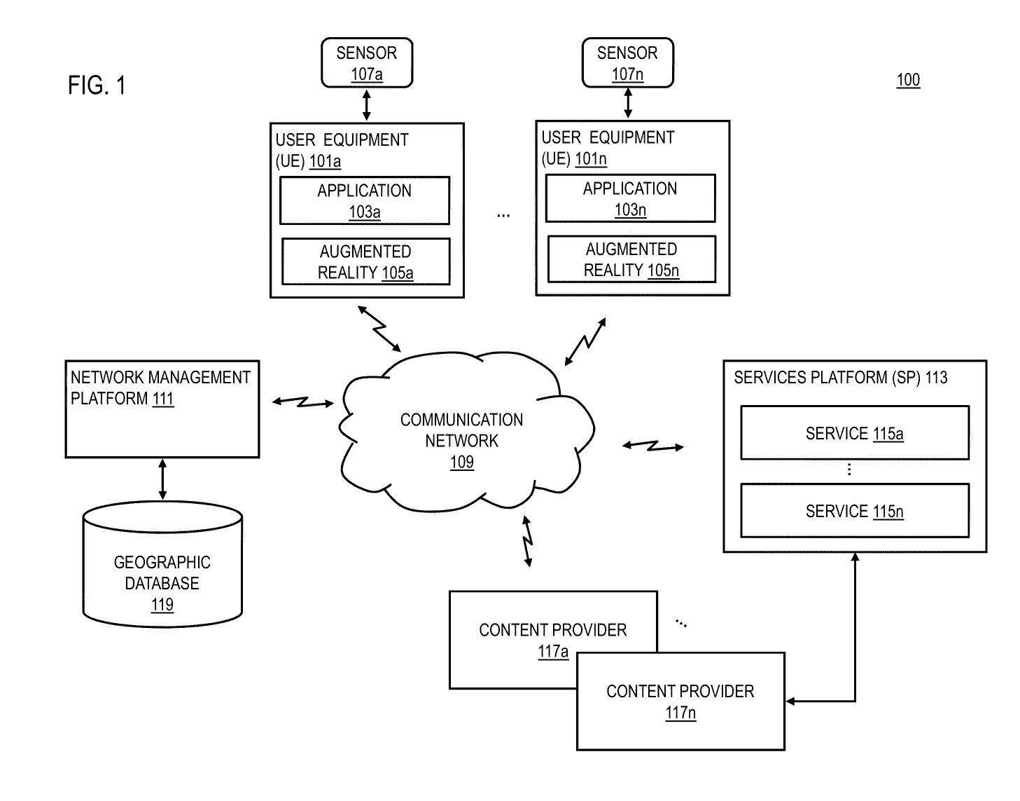

FIG. 1 is a diagram of a system capable of causing a formation of at least one user group network session by a first device, and granting access to the at least one second device upon determining location information between the first device and the at least one second device based, at least in part, on physical proximity, a near field communication, a wireless network, or a combination thereof, according to one embodiment. As discussed previously, although location based services provide a meaningful and convenient means to identify places, landmarks and/or other objects relative to the geo-location of observer (user), it is currently challenging to dynamically track user's contacts who are using similar technology without having to navigate through the complex problems related to data privacy and personal location disclosure permissions. The existing mobile devices do not properly utilize the technology to establish an ad hoc social network using advanced location and augmented reality technologies to achieve visual and spatial awareness of dynamically defined groups. This is due, in part, to the inability of the device or services of the device to accurately utilize the available technologies. Since mobile phones have so far emerged as the most personalized and the most reachable communication device, hence employing a series of location based services, data and sensors available on today's ubiquitous mobile devices, and a unique domain definition method to achieve the establishment of an ad hoc and temporary network may improve user convenience and add value to a mobile phone to make it more competitive. However, one big challenge with the use of mobile devices for establishing ad hoc social network using advanced location and augmented reality technology is that there is currently no convenient means of enabling mobile devices to work within the context of mobile users relying on location based services to establish dynamic social networks in real time. As a result, providers of applications and services for device users are limited in their ability to customize features and services they offer for leveraging existing technologies in the area of augmented reality (AR), location based services, and messaging to implement an ad hoc social network.

To address this problem, a system 100 of FIG. 1 introduces the capability to allow users to opt into a dynamically defined network of peers by connecting UEs 101 through a combination of physical proximity, wireless communications and invitation. This reduces the overhead of authentication and profile creation to publish their position within the group and allow a user which is a member of the group to broadcast and update to other members of the group relative positions over a defined amount of time as defined by each individual in the group. Such session may be terminated by the initiator of the group session. Additionally, once formed, this network can be enhanced to support messaging between group members to mark specific places, choose rendezvous destinations, broadcast places of interest and create a virtual local space for users to interact in a variety of ways (.i.e. communicating, gaming, meeting etc.).

In one scenario, first UE 101a may be configured by the user to set up a user group network session, wherein other UE 101n may be paired with the UE 101a to enable the UE 101a to initiate a network session. In one embodiment, the network session can be quickly initiated by tapping the first UE 101a and the second UE 101n together. The tapping can, for instance, initiate a transfer exchanging identification information over a near field communication (NFC) link between the first UE 101a and the second UE 101n. The information transfer can include one or more identifiers (e.g., a Mobile Subscriber Integrated Services Digital Network Number (MSISDN), an International Mobile Subscriber Identity (EVISI), a wireless pairing identifier such as a BLUETOOTH address, or other UE 101 identifier that can be used by another device or network to identify the UEs 101). The first UE 101a and the second UE 101n can then utilize one of the identifiers to create a wireless link (e.g., a wireless local area network (WLAN) connection, a BLUETOOTH link, a network link over cellular communication, etc.) between the UEs 101.

In one scenario, the wireless link can be authenticated using the identifiers, a preset username and password combination, a pin code, and/or other authentication mechanisms. The authentication information can be stored on the UEs 101 and transferred over the NFC link so that a user need not input information during the network session. Alternatively, the user may confirm the wireless link on one or both UEs 101. The wireless link can then be used to transfer details of active services from the first UE 101a to the second UE 101n. These transfer details can include information needed to forward active online services and or telecommunications services (e.g., voice calls, text messages, etc.) from the first UE 101a to the second UE 101n, vice-versa.

As shown in FIG. 1, the system 100 comprises user equipment (UE) 101a-101n (collectively referred to as UE 101) that may include or be associated with applications 103a-103n (collectively referred to as applications 103), augmented reality application 105a-105n (collectively referred to as augmented reality 105) and sensors 107a-107n (collectively referred to as sensors 107). In one embodiment, the UEs 101 have connectivity to a network management platform 111 via the communication network 109.

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the applications 103 may be any type of application that may perform various processes and/or functions at the UE 101. In one embodiment, the applications 103 may be media (e.g., audio, video, images, etc.) player applications, social networking applications, navigational applications, calendar applications, content (e.g., audio, video, images, etc.) provisioning services, etc. In one embodiment, the applications 103 may generate contextual information regarding the UE 101, or information that may be processed to determine contextual information associated with the UE 101. By way of example, an application may determine location information associated with the UE 101 that may be processed as contextual information. In one embodiment, one of the applications 103a at the UE 101 may act as a client for the network management platform 111 and perform one or more functions associated with the functions of the network management platform 111. In one embodiment, the applications 103 may be a transfer application to transfer active communications between a first UE 101a to a second UE 101n. In one scenario, the application 103a of the first UE 101a can be set to a mode to initiate a transfer while the application 103n of the second UE 101n can be set to a mode to receive a transfer.

In certain embodiments, once a group is created by the network management platform 111, the UE 101 enables the augmented reality 105 to generate real-time representations of the group for one or more collaborative applications environments with virtual computer-generated imagery. More specifically, the view of group is modified or generated by the augmented reality 105 such that the view of the group for one or more collaborative applications presented in any one of the participating UEs 101 is based, at least in part, on an orientation (e.g., location, directional heading, tilt angle, etc.) of the UE 101 in relation to the virtual group. For example, when the UE 101 is operating in an orientation that is within the same plane as the virtual group, the augmented reality 105 may depict, for instance, a virtual window showing a portion of the group for one or more collaborative applications that is visible from the perspective of the UE 101. When the UE 101 is moved or picked up so that the UE 101 is either above or below the plane of the virtual group, the augmented reality 105 may render computer imagery that can pan or zoom over the group for one or more collaborative applications based on the location of the UE 101 with respect to the virtual group. More specifically, by raising the UE 101 above the plane of the virtual group, the augmented reality 105 can render a wider angle view of the group for one or more collaborative applications so that more of the group for one or more collaborative applications is visible in the rendered view of the UE 101. In certain embodiments, the user interfaces of the respective UEs 101 are partial views to the virtual group. Moreover, each of the devices may have different views of the group at different zoom levels. In one scenario, where a user is operating a cell phone with integrated video camera recording the user's current surroundings. The augmented reality 105 operable on the cell phone can interact with the video camera, location detection systems and any other sensory mechanisms of the cell phone, to overlay various graphic elements atop the recorded image or a virtual representation of the recorded image to show the visible portions of the group for one or more collaborative applications and the objects contained therein. The graphic elements can convey useful contextual information to the user regarding the content (e.g., research data, examination questions/answers, online chat/discussion, gaming settings, etc.) being input by the users, content (e.g., images) being captured by user devices, etc. The contextual information may include the names of data objects, addresses, news data, advertisements, other attractions within proximity to the content being input/captured, etc., all in real-time. Moreover, the rendered content is contextually relevant to the services and/or applications (e.g., photo-sharing, gaming, etc.) associated with the virtual group. In the current example, the augmented reality 105 is a client application for generating AR related views respective to detected/shared location, orientation, position, movement or whereabouts information or content (e.g., as determined by the order, sensors, etc.).

In addition, the sensors 107 may be any type of sensor. In certain embodiments, the sensors 107 may include, for example, a camera/imaging sensor for gathering image data, an audio recorder for gathering audio data, a global positioning sensor for gathering location data, a position sensor or gyroscope for detecting device orientation and/or tilt, a network detection sensor for detecting wireless signals or network data, temporal information and the like. This information is provided to the network management platform 111 for processing to determine contextual information associated with UE 101.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the network management platform 111 may be a platform with multiple interconnected components. The network management platform 111 may include multiple servers, intelligent networking devices, computing devices, components and corresponding software for performing the function of providing a formation of at least one user group network session by a first device, and granting access to the at least one second device upon determining location information between the first device and the at least one second device based, at least in part, on physical proximity, a near field communication, a wireless network, or a combination thereof. In addition, it is noted that the network management platform 111 may be a separate entity of the system 100, a part of the one or more services 115 of the service platform 113, or included within the UE 101 (e.g., as part of the application 103). In one scenario, the network management platform 111 may be accessed by UE 101 over, for instance, the communication network 109. A UE 101 may transfer data to the network management platform 111 for receipt by the other UE 101. The network management platform 111 may require authentication that can be set up by either UE 101. It is contemplated that the network management platform 111, the UEs 101, as well as the service platform 113 may employ any authentication mechanism (e.g., username/password, network address filtering, biometric security, etc.) to ensure that only authorized users are able to access the services of the system 100. A location of the UE 101 and the authentication information can be communicated to the other UE 101 by a NFC link, another wireless link.

In one embodiment, the services platform 113 may include any type of service. By way of example, the services platform 113 may include mapping services, navigation services, social networking services, content (e.g., text, images, etc.) provisioning services, application services, storage services, contextual information determination services, location based services, information (e.g., weather, news, etc.) based services, etc. In one embodiment, the services platform 113 may interact with the UE 101, the network management platform 111 and the content providers 117 to supplement or aid in the processing of the content information. By way of example, services 115 may be an online service that reflects interests and/or activities of users. In one scenario, the services 115 provide representations of each user (e.g., a profile), his/her social links, and a variety of additional information. The services 115 allow users to share location information, activities information, contextual information, historical user information and interests within their individual networks, and provides for data portability.

The content providers 117 may provide content to the UE 101, the network management platform 111, and the services 115 of the services platform 113. The content provided may be any type of content, such as textual content, image content, video content etc. In one embodiment, the content providers 117 may provide content that may supplement content of the applications 103, augmented reality 105, the sensors 107, or a combination thereof. In one embodiment, the content providers 117 may also store content associated with the UE 101, the network management platform 111, and the services 115 of the services platform 113. In one embodiment, the content providers 117 may manage access to a central repository of data, and offer a consistent, standard interface to data. In another embodiment, the content providers 117 act as hosts of one or more websites, social networking services, blogs, advertising materials, review information, data feeds, or sources of other information and/or documents.

In one embodiment, the network management platform 111 may include or have access to a geographic database 119 to access or store any kind of data, such as historical user information, location proximity information, temporal proximity information, contextual proximity information, etc. Data stored in the geographic database 119 may, for instance, be provided by the UEs 101, a service platform 113, one or more services 115a-115n (or services 115), or one or more content providers 117a-117n (or content providers 117). In one embodiment, the geographic database 119 may include an index of various locations. The index is able to be queried by the network management platform 111 based on a provided input, such as, from interacting with application 103 via the UE 101.

By way of example, the UE 101, the network management platform 111, the services platform 113, and the content providers 117 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

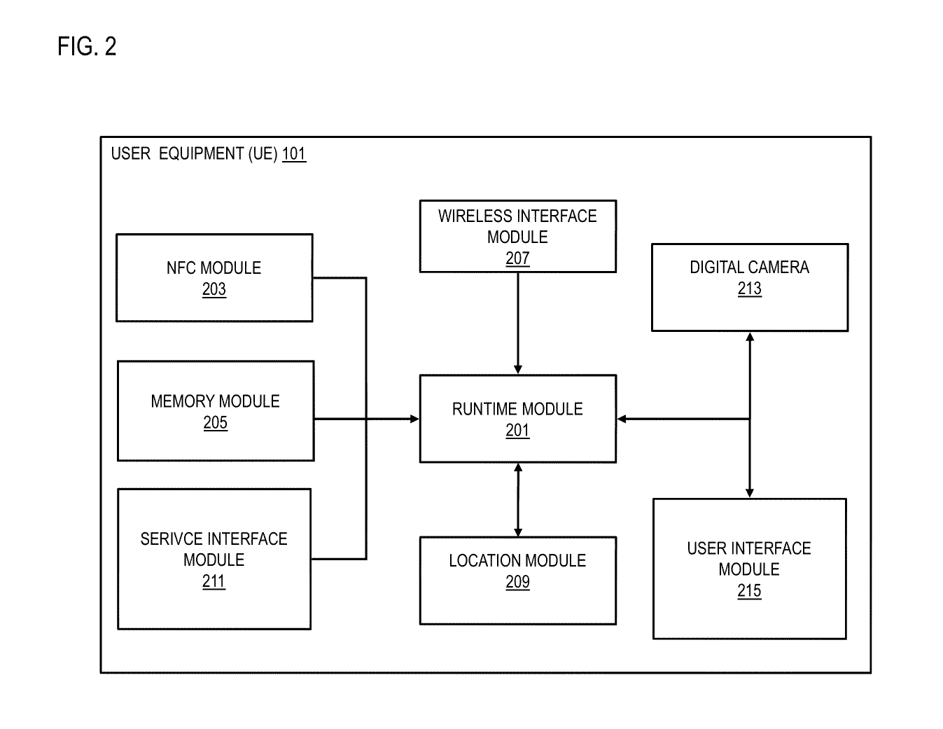

FIG. 2 is a diagram of the components of user equipment (UE) 101, according to one embodiment. By way of example, the UE 101 includes one or more components for transferring services and functionality between UEs 101. It is contemplated that the functions of these components may be combined in one or more components or performed by other components of equivalent functionality. In this embodiment, the UE 101 includes a runtime module 201, an NFC module 203, a memory module 205, a wireless interface module 207, location module 209, service interface module 211, a digital camera 213, and a user interface module 215.

In one embodiment, the runtime module 201 executes application 103 to initiate a network session from a first UE 101a to a second UE 101n. The application 103a of the first UE 101a can be set to initiate transfer mode while the application 103n of the second UE 101n can be set to a receive transfer mode. A user can tap the first UE 101a to the second UE 101n to initiate network session from the first UE 101a to the second UE 101n. In one embodiment, UE 101 may detect the tapping using accelerometers or other movement sensors coupled with one or more mechanism to detect the proximity of the UE 101 (e.g., short range radio such as BLUETOOTH or location information from global positioning satellite receivers and the like). When two UEs 101 are tapped together, an NFC module 203 from each UE 101 can be activated to create an NFC link between the two UEs 101 to transfer information (e.g., identity and authentication information). The transferred information can be stored in the memory module 205.

The NFC module 203 can include an interface to components for conducting NFC and/or the components themselves. NFC technology is a short-range technology that enables two-way interactions between devices. NFC technology can be used to communicate with smartcards, readers, and other NFC devices (e.g., another UE 101). NFC can utilize a magnetic field induction (e.g., using antennas) to communicate with other NFC devices that are located within a certain distance. A NFC device can transmit on a radio band (for instance, the radio band of 13.56 MHz). In one implementation, two UEs 101 can use an active NFC communication mode. Both UEs 101 can communicate with each other by generating a radio frequency field.

A portion of the information transferred via the NFC link may then be utilized by the application 103a of the first UE 101a to setup a wireless connection link (e.g., a WLAN, a BLUETOOTH link, a network link over cellular communication, etc.) via a wireless interface module 207 of each UE 101. The wireless interface module 207 can include physical components to transmit data over the wireless connection link as well as a software component. The wireless interface module 207 may include an identifier that identifies the wireless interface module 207 to other devices to allow for communication. A portion of the information transferred via the NFC link can include the identifier for one or both UEs 101. The application 103a of the first UE 101a can use the identifier to create the wireless connection link. The wireless connection link can be utilized to transfer details of any active or inactive online services from the first UE 101a to the second UE 101n. Active online services can include voice over internet protocol sessions, messaging services, games, e-mail, or other like online services. The details of the online services can include a service identifier, a service location, service authentication information, the current service state, session information, and other service details that can be used to transfer an online service from the first UE 101a to the second UE 101n.

In one embodiment, a UE 101 includes a location module 209. This location module 209 can determine a user's location. The user's location can be determined by a triangulation system such as GPS, A-GPS, Cell of Origin, or other location extrapolation technologies. Standard GPS and A-GPS systems can use satellites to pinpoint the location of a UE 101. In some embodiments, the GPS system can determine an altitude of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 209 may also utilize multiple technologies to detect the location of the UE 101. In some embodiments, wireless local area networks can be used to determine location. In another embodiment, the physical environment can be tagged with location information that can be received by the UE 101.

In one embodiment, a UE 101 includes a service interface module 211. The service interface module 211 is used by the runtime module 201 to communicate with the network management platform 111. In some embodiments, the service interface module 211 is used to send and receive UEs 101 information to the network management platform 111.

In some embodiments, a UE 101 includes a digital camera 213. Images can be captured or streamed using the digital camera 213 in the form of an image. The digital camera can also utilize a zoom function. If the zoom function is used, the digital camera 213 can embed the image with metadata regarding the zoom lens. A runtime module 201 can process the image or a stream of images to send content to the network management platform 111 via user interface module 215.

In one embodiment, the user interface module 215 of the UE 101 can include various methods of communication. For example, the user interface module 215 can include outputs including a visual component (e.g., a screen), an audio component (e.g., amplifiers and speakers), a physical component (e.g., vibrations), and other methods of communication. User inputs can include a touch-screen interface, a scroll-and-click interface, a button interface, a microphone, etc. A user can utilize services from the service platform 113 using, for instance, applications 103 of the UE 101.

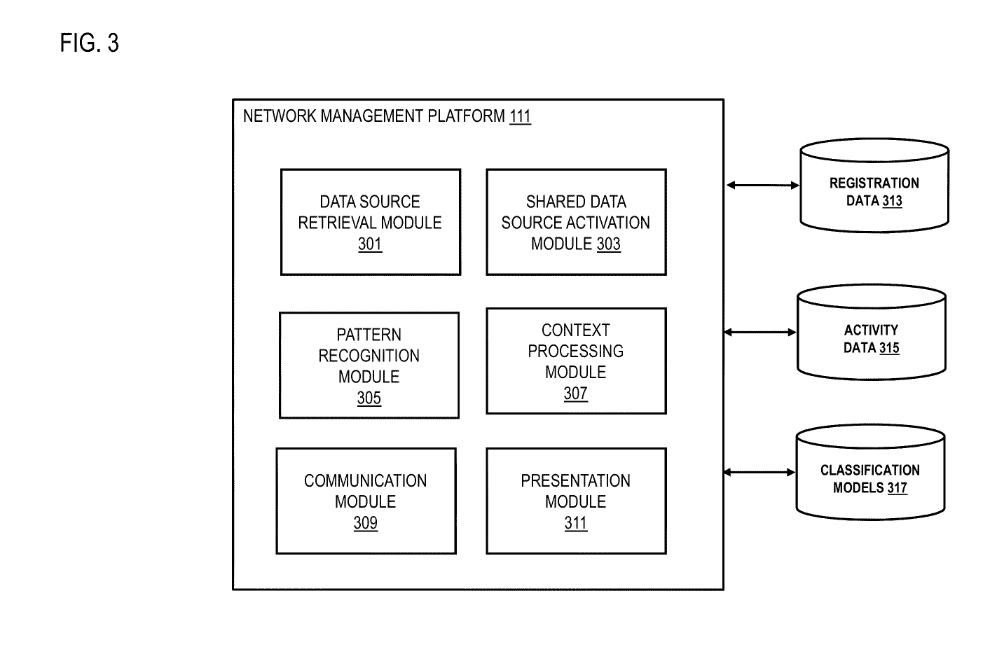

FIG. 3 is a diagram of a network management platform 111 for causing a formation of at least one user group network session by a first device, and granting access to the at least one second device upon determining location information between the first device and the at least one second device based, at least in part, on physical proximity, a near field communication, a wireless network, or a combination thereof, according to one embodiment. By way of example, the network management platform 111 may include a data source retrieval module 301, a shared data source activation module 303, a pattern recognition module 305, a context processing module 307, a communication module 309, and a presentation 311. In addition, the various modules of the platform 109 accesses one or more databases for enabling execution of its various functions. These databases include a registration data 313, activity data 315 and classification models 317.

In one embodiment, a data source retrieval module 301 retrieves activity data and timing information as maintained by the various user devices. The data source retrieval module 301 may be configured to perform on demand retrieval of the data or alternatively, periodic data exchange with the UEs 101. Data retrieval may be triggered by the network management platform 111, such as in response to the detection of input generated by one or more of the sensors of the user device 101 i.e., microphone, camera, antennas, touch screen, etc. As data is collected from multiple different modules of UE 101, the data is stored with reference to a specific user or user device as indicated with respect to the registration data 313. Once associated, the data is further aggregated as activity data 315 where it may be mined by a pattern recognition module 305 for determining larger proximity-relationship suggestions. It is noted that the timing information associated with a given set of activity data 315 is useful for establishing a relative event occurrence or context relative to proximity based interaction among devices.

In one embodiment, a shared data source activation module 303 triggers the execution of a resource to be shared among user devices based on exhibited proximity patterns. The resource may be a data source, application or combination thereof to be shared among group members given the current classification of the patterns. In one scenario, there is a “Running Group,” the shared data source activation module 303 may initiate distribution of running related data with the one or more devices based on the corresponding predetermined pattern. It is noted, therefore, that the shared data source activation module 303 may be configured by a user, automatically by the network management platform 111 based (e.g., as based on metrics, statistics or historical activity data), or a combination thereof, for causing a predetermined action to be taken by the one or more devices based on a given pattern classification.

In one embodiment, a pattern recognition module 305 analyzes the activity data and timing information in order to classify the activity as one or more patterns. The pattern recognition module 305 processes the activity data and timing information by way of one or more known pattern recognition techniques. Recognition techniques may include the assignment of output values (labels or tags) to a given input value as included as part of the activity data set 315. Another approach may include classification processing, wherein the pattern recognition module 305 assigns each input value of the activity data 315 to one of a given set of classes, such as defined according to one or more classification models 317.

By way of example, classification models 317 are utilized by the pattern recognition module 305 for enabling proper classification of a group relative to a determined pattern. A classification model 317 may specify one or more parameters associated with a particular group, including common SSIDs, IP data and other inputs that may be representative of group patterns. As such, the pattern recognition module 305 exercises various processing rules for application of the activity data against the classification models 317. Under this scenario, the pattern recognition module 305 may assign a particular classification to a determined pattern. It is noted that a classification may be a representative group name, proximity based context or profile descriptive of a certain pattern. For example, a group of user devices belonging to a running group at a club in connection with a detected SSID of a club computer may be classified as “Running Group.”

In one embodiment, the context processing module 307 receives context information as gathered by the sensors 107 of respective UE 101 and/or services 115. Once received, the context processing module 307 analyzes the context information to determine the relative location, time, position and other information useful for granting access to a user group network session. Based on this determination, the context processing module 307 triggers execution of the communication module 309.

In one embodiment, a communication module 309 enables formation of a session over a communication network 109 between the network management platform 111 and the services 115. By way of example, the communication module 309 executes various protocols and data sharing techniques for enabling collaborative execution between a subscriber's UE 101 and the network management platform 111 over the communication network 109.

The presentation module 311 makes a presentation of user group network session upon receiving the data from communication module 309. This module obtains a set of summary statistics from other modules. Then, the module continues with generating a presentation and continues with providing of presentation data set where the presentation could be depicted in one or more visual display units.

The above presented modules and components of the network management platform 111 can be implemented in hardware, firmware, software, or a combination thereof. Though depicted as a separate entity in FIG. 1, it is contemplated that the network management platform 111 may be implemented for direct operation by respective UE 101. As such, the network management platform 111 may generate direct signal inputs by way of the operating system of the UE 101 for interacting with the application 103. In another embodiment, one or more of the modules 301-311 may be implemented for operation by respective UEs, network management platform 111, or combination thereof. Still further, the network management platform 111 may be integrated for direct operation with services 115, such as in the form of a widget or applet, in accordance with an information and/or subscriber sharing arrangement. The various executions presented herein contemplate any and all arrangements and models.

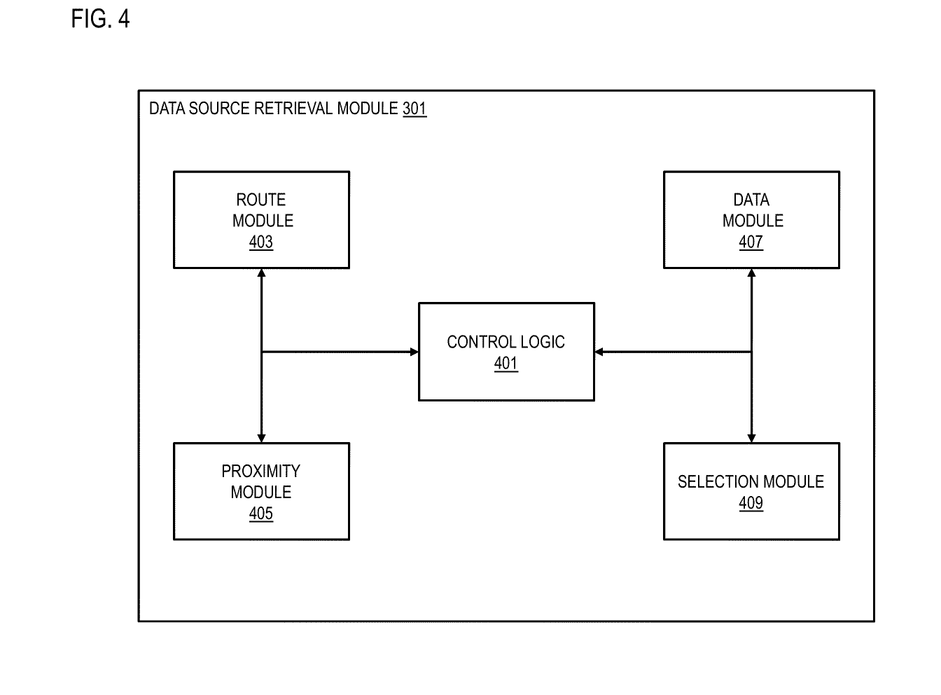

FIG. 4 is a diagram of the components of the data source retrieval module 301, according to one embodiment. By way of example, the data source retrieval module 301 includes one or more components for causing an update and/or generation of index for various data related to UEs 101. It is contemplated that the functions of these components may be combined in one or more components or performed by other components of equivalent functionality. In this embodiment, the data source retrieval module 301 includes a control logic 401, route module 403, proximity module 405, data module 407 and selection module 409.

The control logic 401 executes at least one algorithm for executing functions at the presentation module 311. For example, the control logic 401 may interact with the route module 403 to receive one or more geo-routes associated with one or more UEs 101. In one embodiment, the route module 403 may determine one or more geo-routes using historical and/or predicted user information, such as the daily work commute traveled by one or more UEs 101. With the one or more geo-routes, the control logic 401 and the proximity module 405 may determine proximity information of one or more UEs 101 to one or more point of interest (POI). The control logic 401 and the proximity module 405 may determine proximity information that includes, at least in part, location, temporal, contextual proximity information, or a combination thereof.

The control logic 401 and data module 407 may define location based information or the like, for instance, POIs, location anchored messages, pictures, videos, animations etc, while the selection module 409 may select UEs 101 based, at least in part, on the proximity information determined by the proximity module 405. For instance, the selected UE 101 with one or more geo-routes and/or one or more location anchors within a certain proximity threshold of one or more UEs 101 may be chosen out of all the other UEs 101. Alternately, the control logic 401 and selection module 409 may sort the one or more UEs 101 based on proximity information.

In one embodiment, the selection module 409 may select the one or more UEs 101 based, at least in part, on the location information. For instance, one or more UEs 101 may be selected because the history of geo-routes indicates that they will soon be proximate location (e.g., regardless of whether the UEs 101 are already in the location, as the predicted user information suggests that UEs 101 may soon be within the vicinity). Further, the selection module 409 may determine one or more predicted locations of a user based, at least in part, on the ease of access from a location associated with the UEs 101.

Further the selection module 409 may interact with other modules of network management platform 111 to direct the one or more UEs 101 to the chosen POI. For example, the control logic 401 and application 103 may work together to determine navigation guidance information to cause, at least in part, a presentation of the one or more POI. In one scenario, this may include UEs 101 displaying directions on how to reach POI.

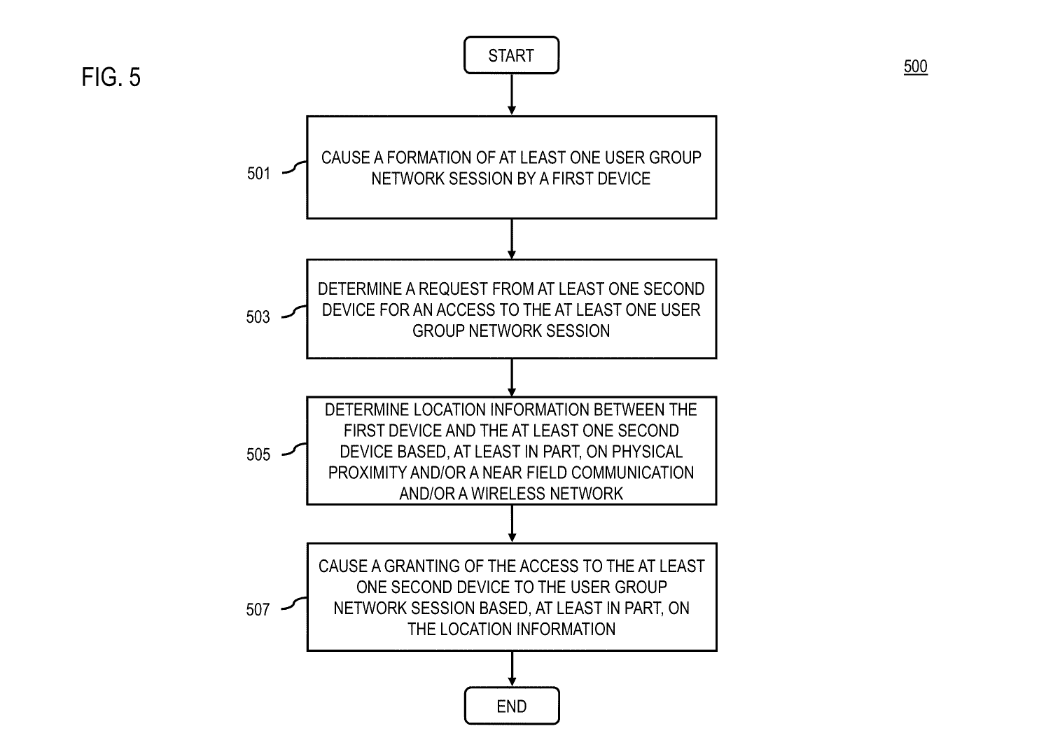

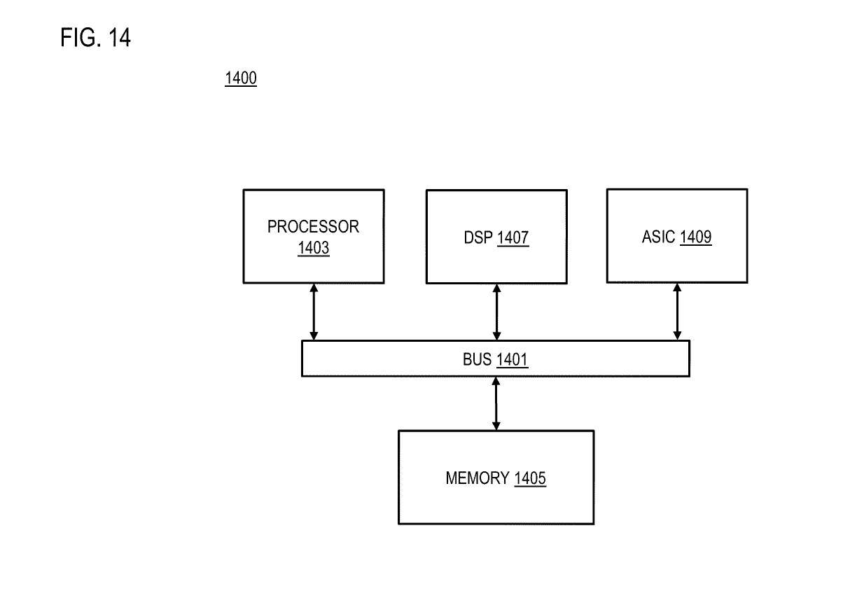

FIG. 5 is a flowchart of a process for causing a formation of at least one user group network session by a first device, and granting access to the at least one second device upon determining location information between the first device and the at least one second device based, at least in part, on physical proximity, a near field communication, a wireless network, or a combination thereof, according to one embodiment. In one embodiment, the network management platform 111 performs the process 500 and is implemented in, for instance, a chip set including a processor and a memory as shown in FIG. 14.

In step 501, the network management platform 111 causes, at least in part, a formation of at least one user group network session by a first device via, for instance, application 103. In one scenario, ‘user z’ may not access online group service because some of the immediate problems that surfaces with accessing online services are permissions pertaining to publishing and access to private information. For instance, a ‘Semi-private’ network where ‘opt-in’ is based on similar set of constraints, wherein a user has to sign-in creative accounts and share private information. Such requirement may be significant to a point where a lot of people may not access the service, therefore, a need persists to solve the ‘opt-in’ issue seamlessly and naturally, by creating a specific set of strong differentiating capability around the modicum of innovation by allowing users to dynamically form groups, such as, family at Disneyland, family reunions etc. In one scenario, the network management platform 111 allows dynamic formation of a group, manage this group, and maintain privacy and security for the group.

In step 503, the network management platform 111 determines a request from at least one second device for an access to the at least one user group network session. In one scenario, when a user sends a request to the network management platform 111 to access the user group network session, the network management platform 111 may process the user request if the location information of the request sending UE 101 indicates that the user is within a predetermined proximity.

In step 505, the network management platform 111 determines location information between the first device and the at least one second device based, at least in part, on physical proximity, a near field communication, a wireless network, or a combination thereof. In one scenario, a UE 101 may access the service by simply tapping the transferring UE 101a with the receiving UE 101n configured to receive transferred services. The proximity of the two UEs 101 may be determined by, for instance, using short range radio (e.g., BLUETOOTH, WIFI) or location-based services (e.g., GPS, cellular triangulation, etc.). In one scenario, the network management platform 111 may allow sharing of information relating to a nearby event, where the service has defined the size of nearby. In one scenario, the at least one user to the network session may define the size of nearby, wherein the at least one user may define the area where the network session may be maintained. For instance, a user may define a bounding region outside of which the participants to a network session may not be considered a part of the network session, as an optional parameter.

In step 507, the network management platform 111 causes, at least in part, a granting of the access to the at least one second device to the user group network session based, at least in part, on the location information. In the above scenario, when a UE 101 sends a request to the network management platform 111 to access the network session, the network management platform 111 may grant the UE 101 with access if the location information of the UE 101 indicates that the user is within proximity (.i.e. physical proximity and/or a near field communication and/or a wireless network). For instance, if the primary UE 101 is located at “123 ABC Street”, the location information of the request sending device should be within the physical proximity and/or a near field communication and/or wireless network proximity from “123 ABC street”. In one scenario, the radius of some groups may be dynamically changeable, for instance, there may be a cycling competition, in one day the location may be ‘x’ place and in another ‘y’ place. In one scenario, a member of a user group network session may move away from the predefined location, he/she may not need to use NFC to come back to the members of the group, the service may track his/her movements and if he/she gets back within certain time within the predefined location, he/she may get back to the user group network session based on location information.

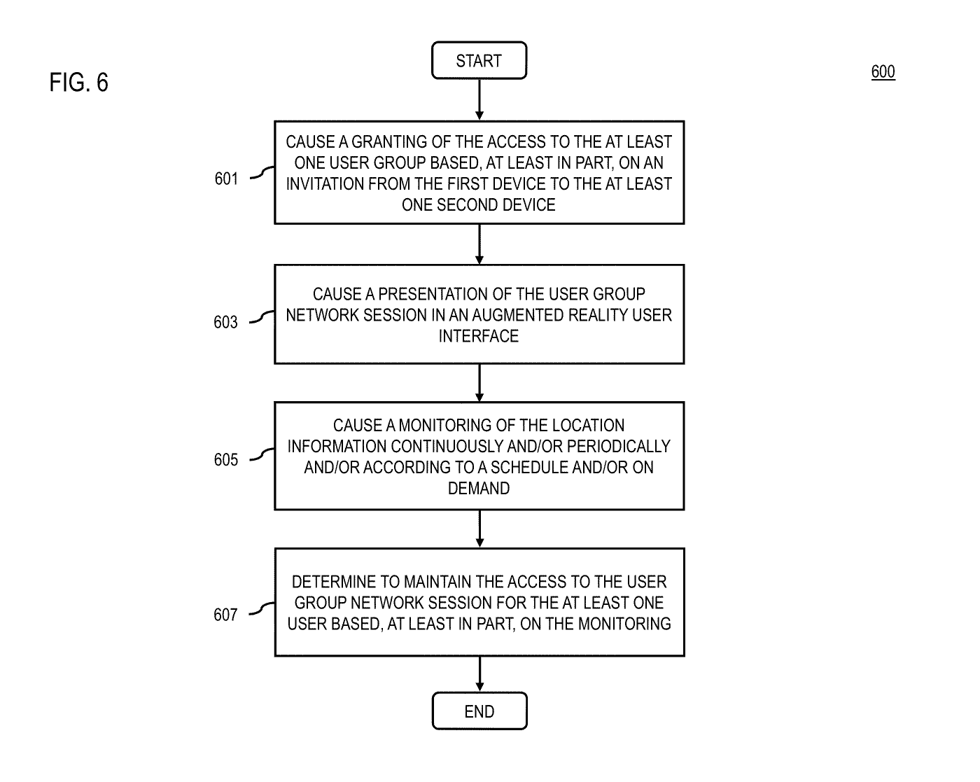

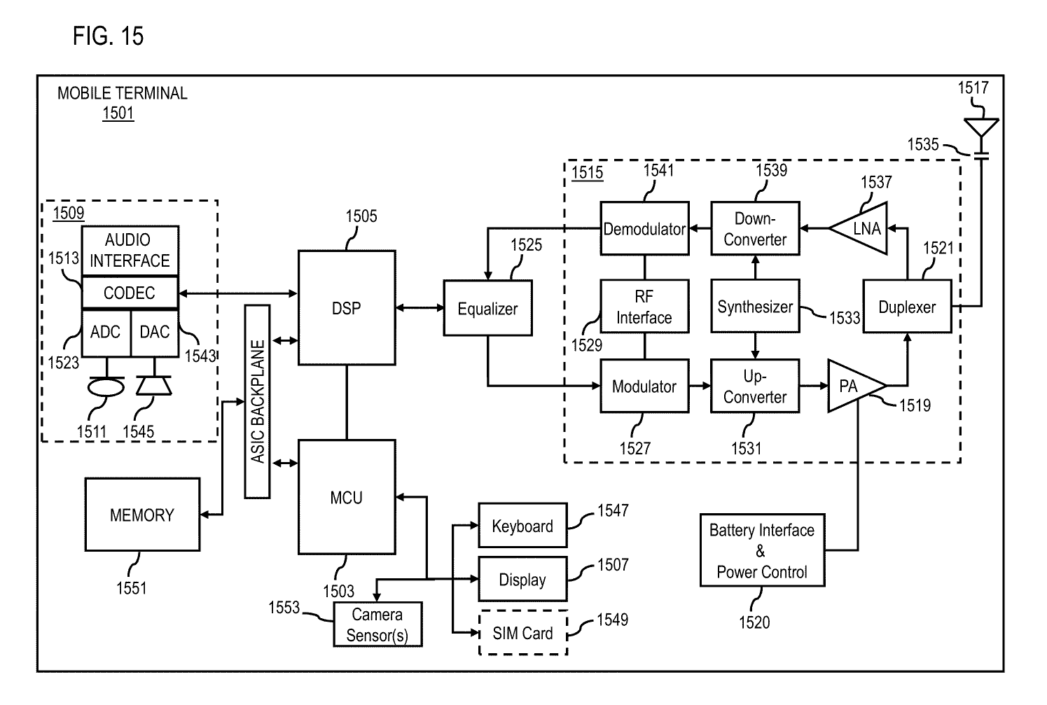

FIG. 6 is a flowchart of a process for granting access to the at least one user group on an invitation from the first device to the second device, and presenting the user group network session in an augmented reality user interface. The flowchart further provides a process for monitoring the location information and determining to maintain access to the user group network session based, at least in part, on the monitoring, according to one embodiment. In one embodiment, the network management platform 111 performs the process 700 and is implemented in, for instance, a chip set including a processor and a memory as shown in FIG. 15.

In step 601, the network management platform 111 causes, at least in part, a granting of the access to the at least one user group based, at least in part, on an invitation from the first device to the at least one second device. In one scenario, a first device may have formed a user group network session, the first device may invite a second device to join the network session. In this regard, the first user may provide for the generation of an invitation to the second device. As such, in response to the generation of this invitation, user associated with the second device may accept the request to access the user group network session. In one embodiment, an invitation may be any type of communication that may be conveyed to a mobile device, such as, for example, an invitation to join a social network or the like. In some embodiments, user contact may be received in response to generation of an invitation associated with a user.

In step 603, the network management platform 111 causes, at least in part, a presentation of the user group network session in an augmented reality user interface. In one scenario, the runtime module 201 may receive an image representing a physical environment. The physical environment can be an area surrounding a UE 101. The runtime module 201 can receive the image from an image capture device (e.g., a digital camera 213 etc.). In one embodiment, data may be retrieved from an accelerometer sensor, a compass sensor (e.g., a magnetometer), a gyroscope, an altimeter, an image sensor, a location module or a combination thereof. In one embodiment, compass data may be used to calculate the direction of the UE 101 as compared to a fixed location. In another embodiment, accelerometer data may be used to determine the angle of the UE 101 as compared to the ground by comparing the acceleration of gravity to a fixed point on the UE 101. In yet another embodiment, gyroscope data may be used to determine the orientation of the UE 101 by measuring the turning of the UE 101. In addition, altimeter data may be used to determine the height of the UE 101. In yet another embodiment, the image may be processed (e.g., using color sensing schemes, light sensing schemes, etc.). In other embodiments, sensor data can be used to determine types of movement (e.g., running, jumping, riding in a car, etc.) of the UE 101 as each movement may correspond to specific periodic accelerations. As such, the presentation module 311 initiates presentation of the structural information on a display of the UE 101, so that a user can more easily understand a surrounding physical environment of the other user. In one scenario, the network management platform 111 may provide a view of the established group defined by the IDs and location parameter of the group within said predefined nearby. In one scenario, the definition of nearby may be contextual and may be based, at least in part, on the activity, for instance, the size of nearby may be smaller for a concert gathering, on the contrary the size of nearby may be larger for a snow ski outing etc., and may not have a hard boundary.

In step 605, the network management platform 111 causes, at least in part, a monitoring of the location information continuously, periodically, according to a schedule, on demand, or a combination thereof. Further, the network management platform 111 causes an update of the location information for one or more mobile devices based, at least in part, on the monitoring.

In step 607, the network management platform 111 determines to maintain the access to the user group network session for the at least one user based, at least in part, on the monitoring.

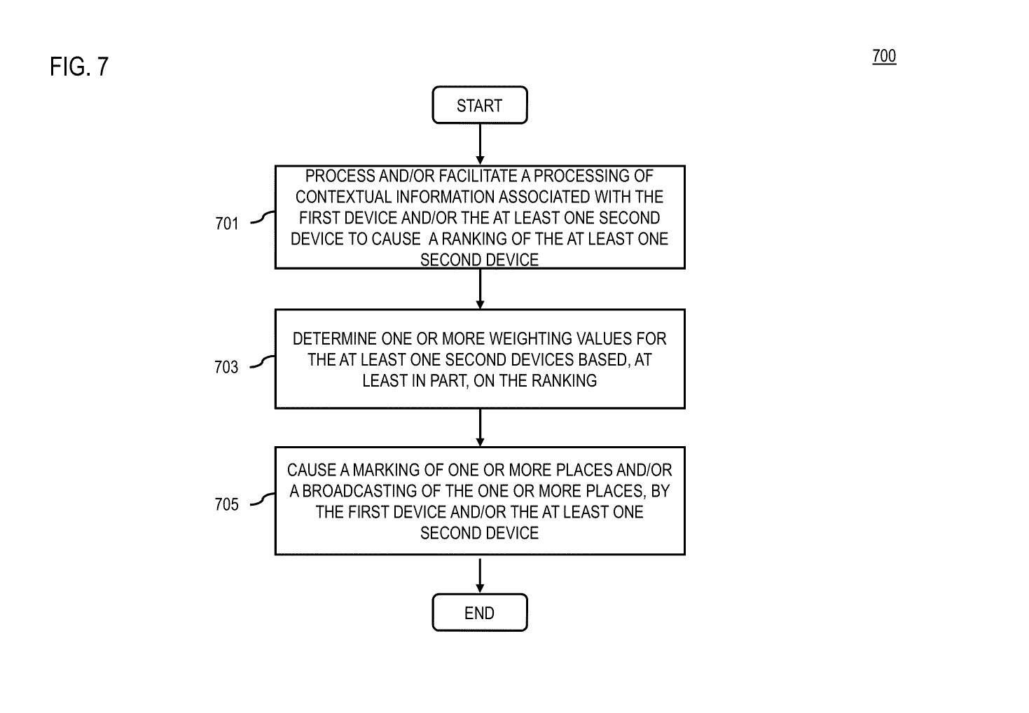

FIG. 7 is a flowchart of a process for processing contextual information associated with the first and/or second devices for causing a ranking of the at least one second device based, at least in part, on a physical proximity and/or social proximity to the first device, and further causing a marking and/or broadcasting of the one or more places by the first device and/or the at least one second device, according to one embodiment. In one embodiment, the network management platform 111 performs the process 700 and is implemented in, for instance, a chip set including a processor and a memory as shown in FIG. 14.

In step 701, the network management platform 111 processes and/or facilitates a processing of contextual information associated with the first device, the at least one second device, or a combination thereof to cause, at least in part, a ranking of the at least one second devices based, at least in part, on a physical proximity, a social proximity, or a combination thereof to the first device. In one embodiment, contextual information may include, at least in part, user profile information and/or user preference information and/or location information and/or temporal information and/or activity information.

In step 703, the network management platform 111 determines one or more weighting values for the at least one second devices based, at least in part, on the ranking. In one scenario, contextual information may be historical data of a mobile device regarding the user's usage of online services can be collected by the network management platform 111. An analysis of the data by the network management platform 111 may select or recommend which user group network sessions should be activated and/or transferred to the receiving UE 101. For example, data can be collected that the user is interested in Hollywood movies, the profile can then be set by the network management platform 111 to initiate recommendation of movies related network sessions, if any, to the receiving UE 101. Additionally, the profile can be set to utilize the historical usage in setting the priority order of transferring or activating network sessions. An application (e.g., a calendar application) on the transferring UE 101a can also have access to the profile. The application can determine which online services should be activated and/or transferred based on preset configurations. For example, a calendar application can have a scheduled ‘family reunion party’ on Friday at 3 pm. The calendar application can set the profile to activate a ‘family reunion party’ online service (e.g., to collect data of the user and provide guidance) during a set time frame if a transfer occurs during this time frame.

In step 705, the network management platform 111 causes, at least in part, a marking of one or more places, a broadcasting of the one or more places, or a combination thereof, by the first device, the at least one second device, or a combination thereof. In one scenario, once a user group network session is formed, this network can be enhanced to support messaging between group members to mark specific places, choose rendezvous destinations, broadcast places of interest and create a virtual local space for users to interact in a variety of ways. In one scenario, if there is a concert at a certain location, then the location can be marked by the user, and a message may be sent to the member of the user group network session, wherein the recipient can look at the camera and look across the venue and find the rendezvous point.

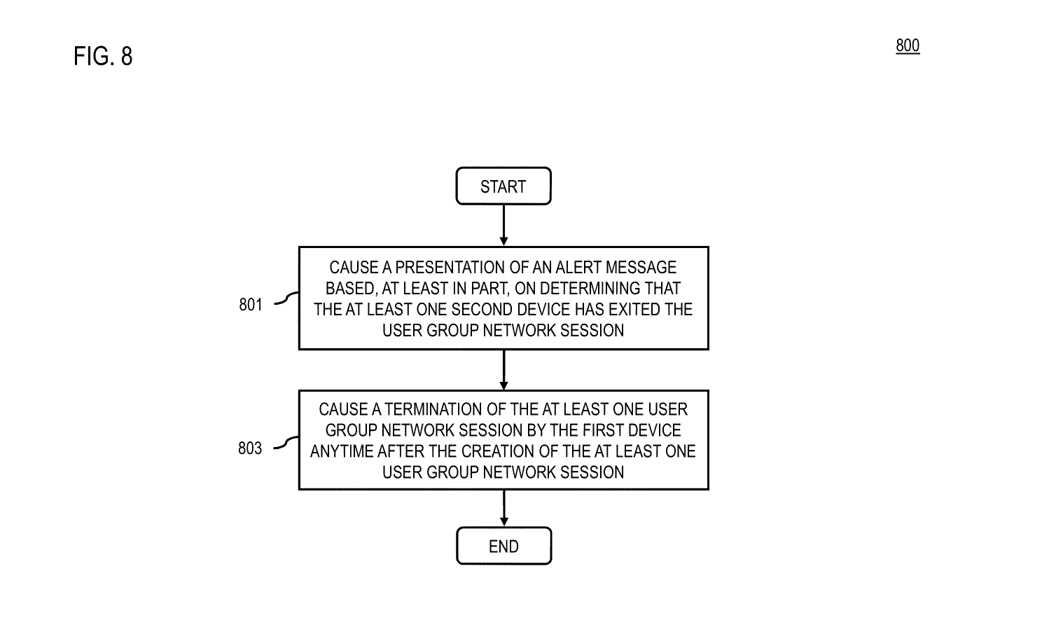

FIG. 8 is a flowchart of a process for causing a presentation of an alert message on determining that at least one second device has exited the user group network session. The flowchart further provides a process for termination of the at least one user group network session by the first device any time after the creation of the at least one user group network session, according to one embodiment. In one embodiment, the network management platform 111 performs the process 800 and is implemented in, for instance, a chip set including a processor and a memory as shown in FIG. 14.

In step 801, the network management platform 111 causes, at least in part, a presentation of an alert message based, at least in part, on determining that the at least one second device has exited the user group network session. In one embodiment, the at least one second device may exit the at least one user group network session at any point after joining the session. In one scenario, a user creates a group and can add membership to the group by touching the phones by creating an NFC event. Basically there is a session master, who creates a session and the invitation to join the session may be extended and accepted by the recipient, a backend proxy creates a session that is not time based per se. Essentially, the session stays alive as long as the creator wants the session to be alive and the members can opt out from the session whenever he/she wants out.

In step 803, the network management platform 111 causes, at least in part, a termination of the at least one user group network session by the first device any time after the creation of the at least one user group network session. In one scenario, the session creator may terminate the group once the event has passed and/or within predefined time from the passed time. In one scenario, a usage of maximum time by the at least one member and/or exceeding the predefined distance radius by the at least one member and/or the at least one member of the user group network session terminating their participation at any time of their choosing may be a criteria for terminating a network session. In one scenario, when some of the criteria to terminate a network session is fulfilled for the at least one user, for instance, the user went outside the predefined distance, the user may be disconnected from the network session, while the whole network session remains unaffected and continues for other members to the network session.

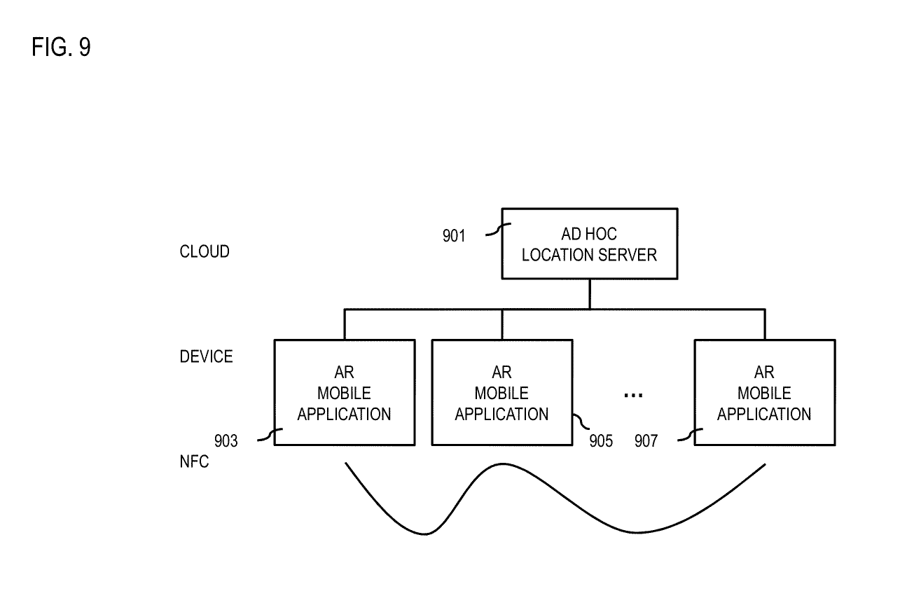

FIG. 9 is a diagram of user interfaces utilized in the processes of FIGS. 5-8, according to various embodiments. For example, FIG. 9 illustrates a touch, share and play method or interface for sharing and interacting with an AR environment for causing presentation of at least a portion of the data, additional data, or a combination thereof between one or more UEs 101. In one embodiment, FIG. 9 illustrates the architectural layout of a paradigm which shows a proxy backend to manage group's location lifecycle. The architecture shows three layers depicting the data, processing and communications medium modules. An “AR browser or app” can be termed an AR element or node. Each node represents an app user who has a processing module, i.e. a smart device with the required capabilities (.i.e. user interfaces 903, 905 and 907).

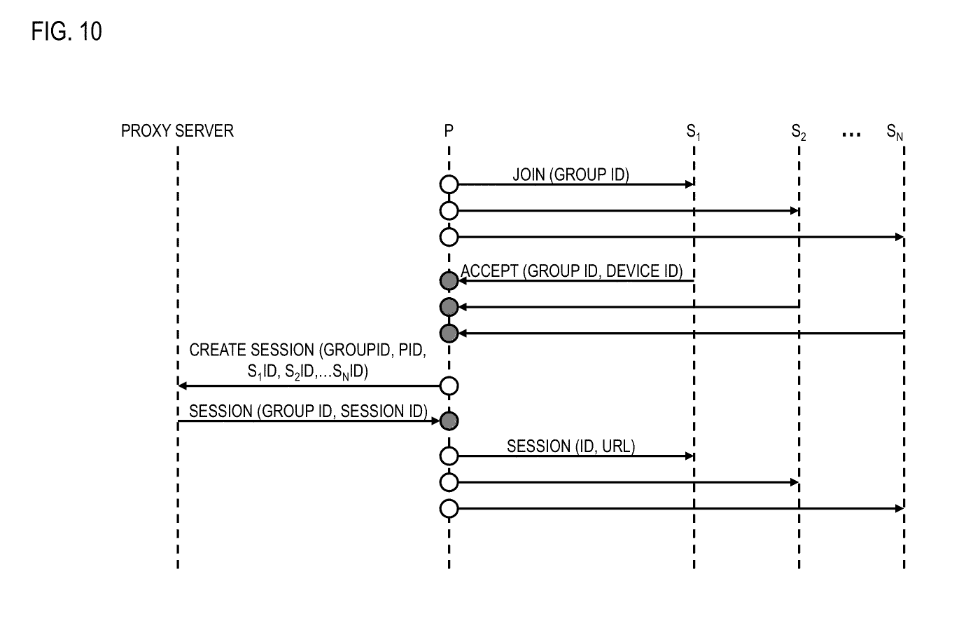

FIG. 10 is a diagram of user interfaces utilized in the processes of FIGS. 5-8, according to various embodiments. For example, FIG. 10 illustrates a data flow establishing a city lens active group. It depicts how each AR element or node can be connected to establish a group using the close NFC proximity communication capable devices. The data structure of the group may comprise but is not restricted to a set of identifiers namely group, place (geo-location Long/Lat), and device type. In one embodiment, a session may be allocated an identifier based on the acceptance or creation of group and comprises of a group and session identifier in form of an accessible link, i.e., a URL which can be transmitted over wireless communication. In one scenario, P may be the primary device that sends out the invitations, creates the list, talks to their backend to get the session-id and propagates that session id back to the secondary devices (.i.e. S1, S2 . . . Sn) to create the user group network session.

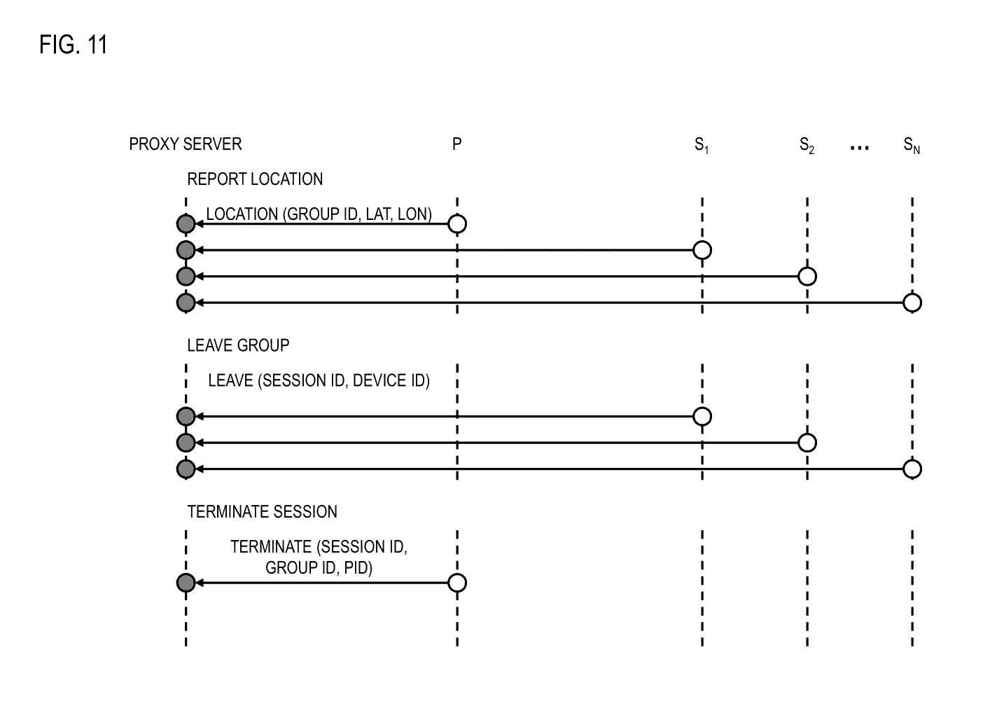

FIG. 11 is a diagram of user interfaces utilized in the processes of FIGS. 5-8, according to various embodiments. For example, FIG. 11 illustrates a data flow intra-group interaction between users. It illustrates interaction within the established group of users. Such interaction between and within groups can be managed by a dedicated proxy server over a distributed communication and data management infrastructure. A number of actions can be executed namely reporting a geo-location, leaving a group session by the at least one second device or terminating a session by the first device, as shown in the figure.

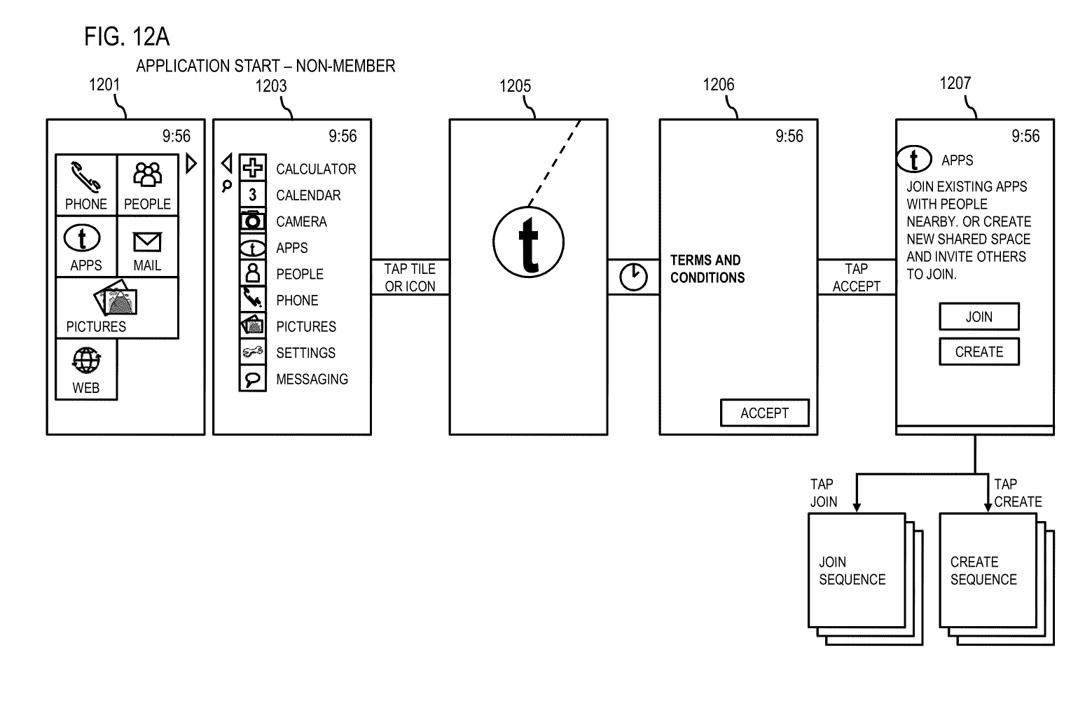

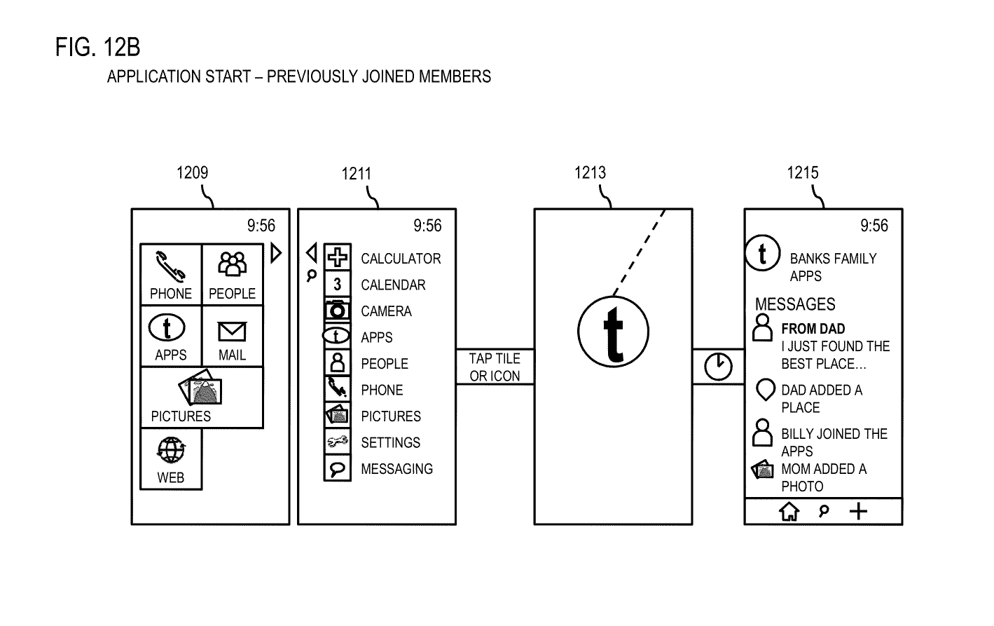

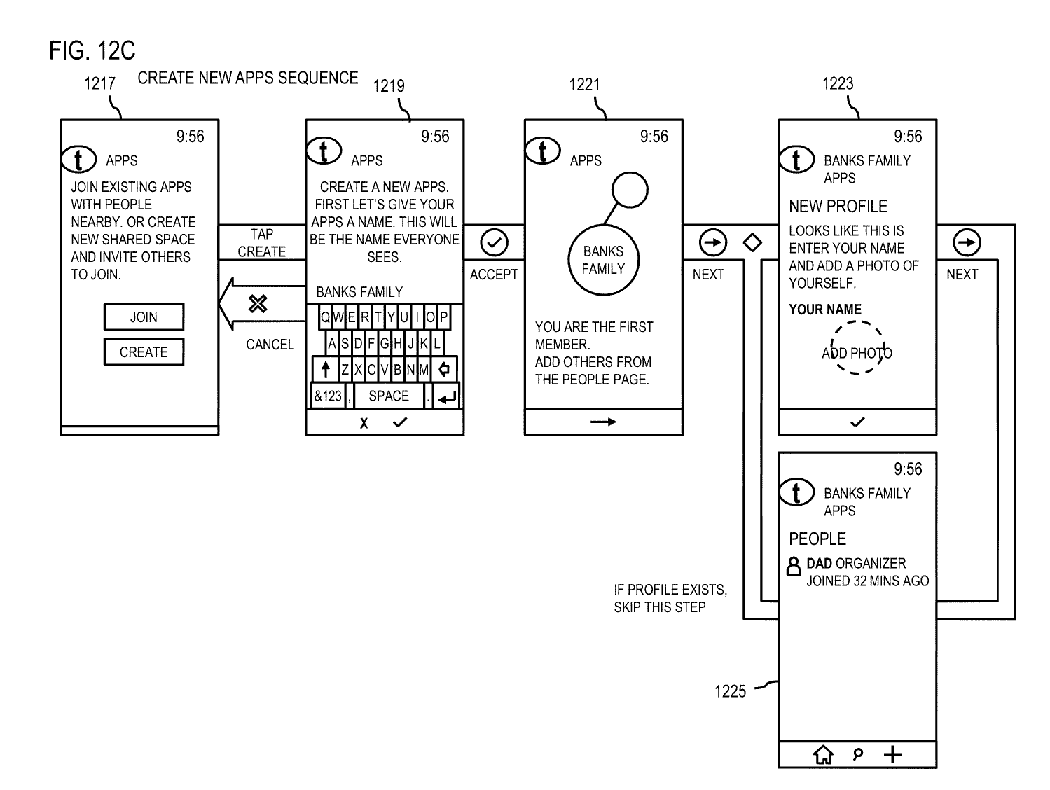

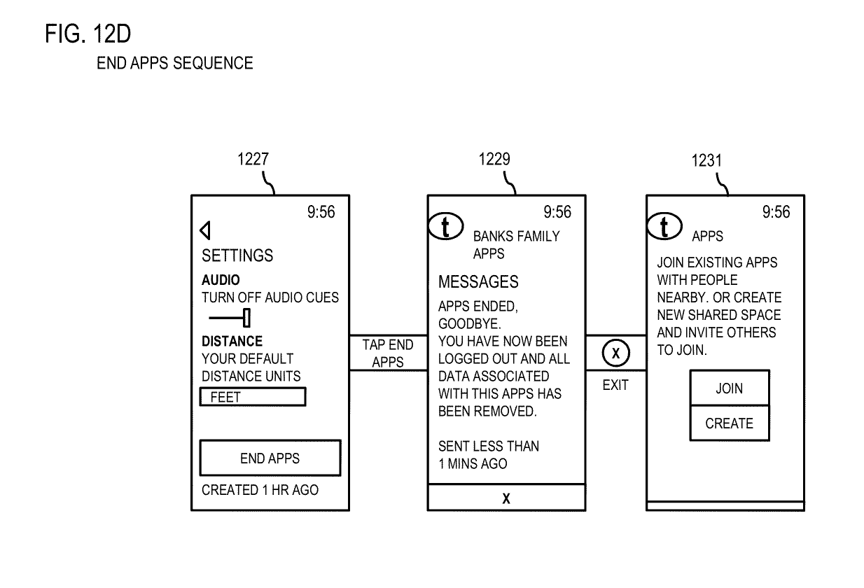

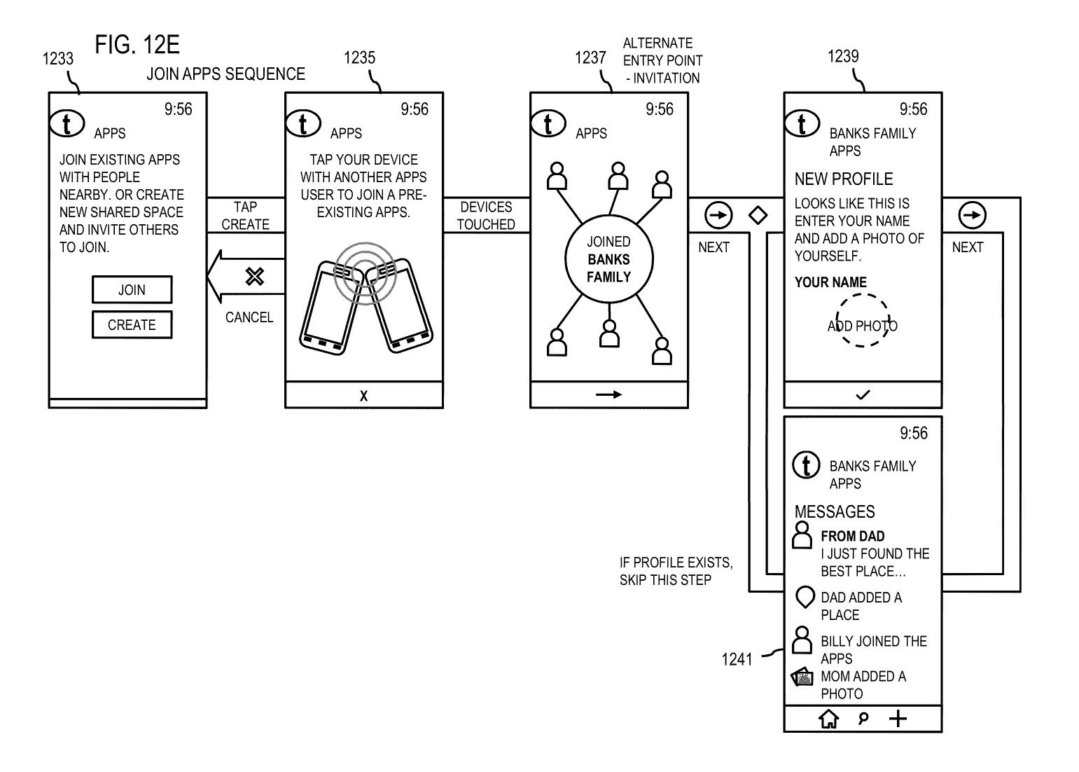

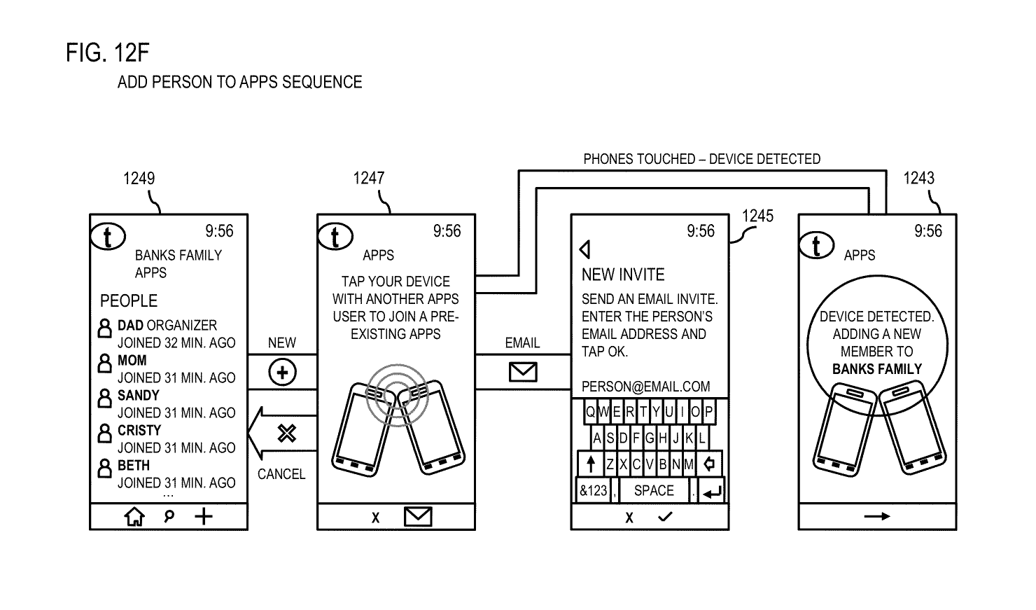

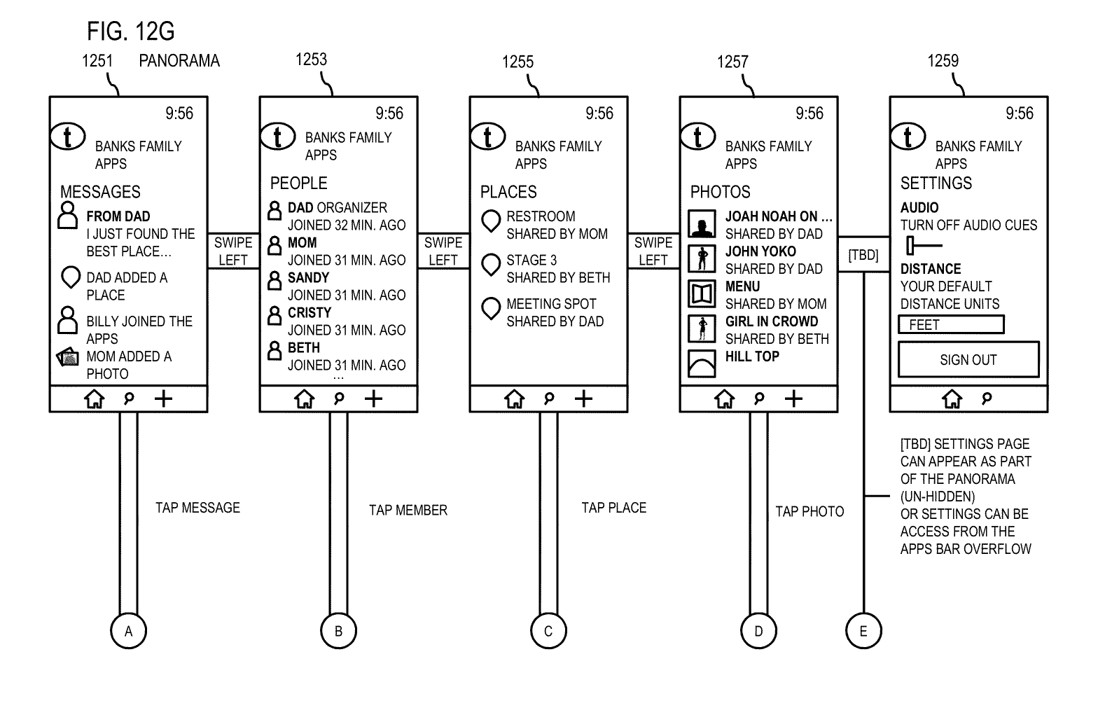

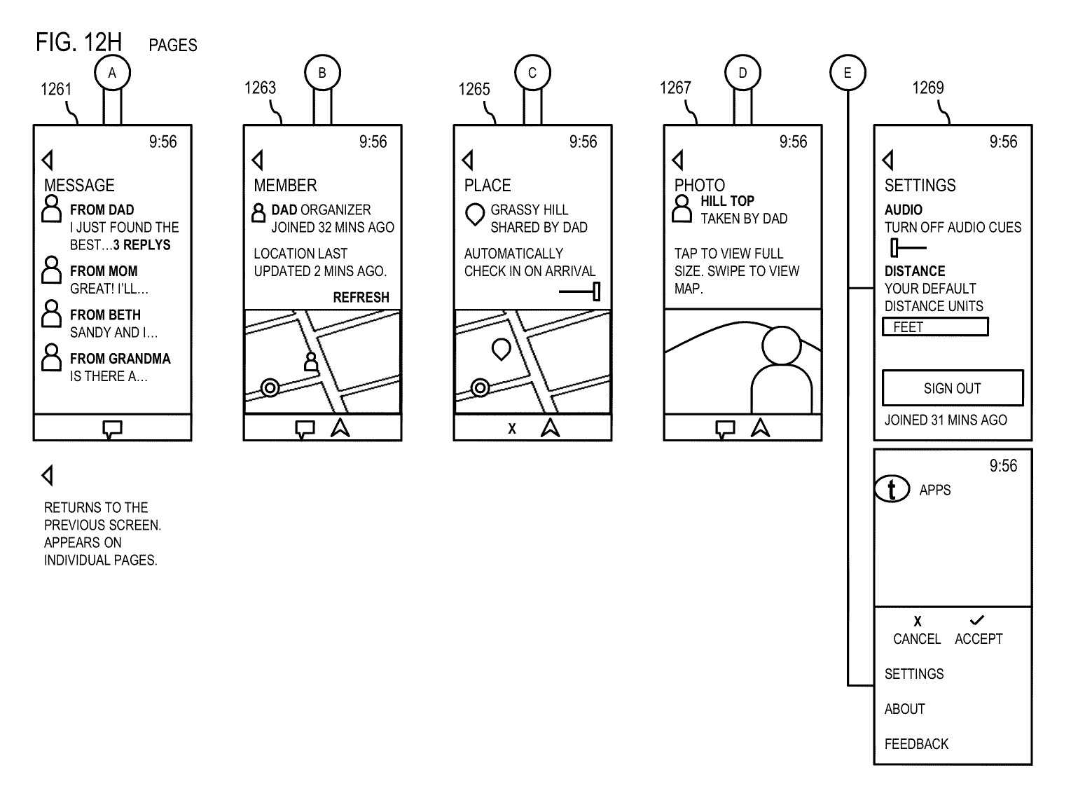

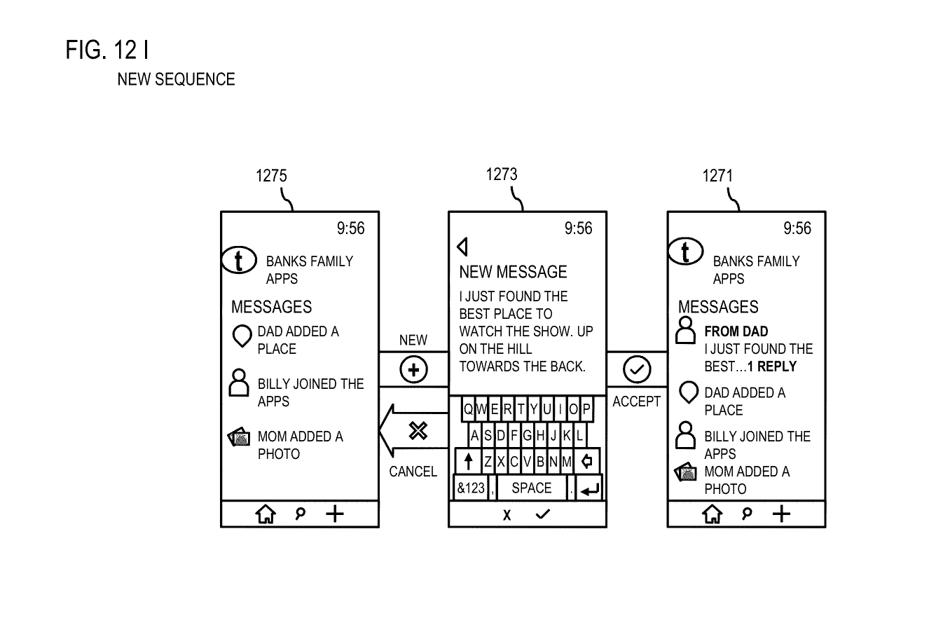

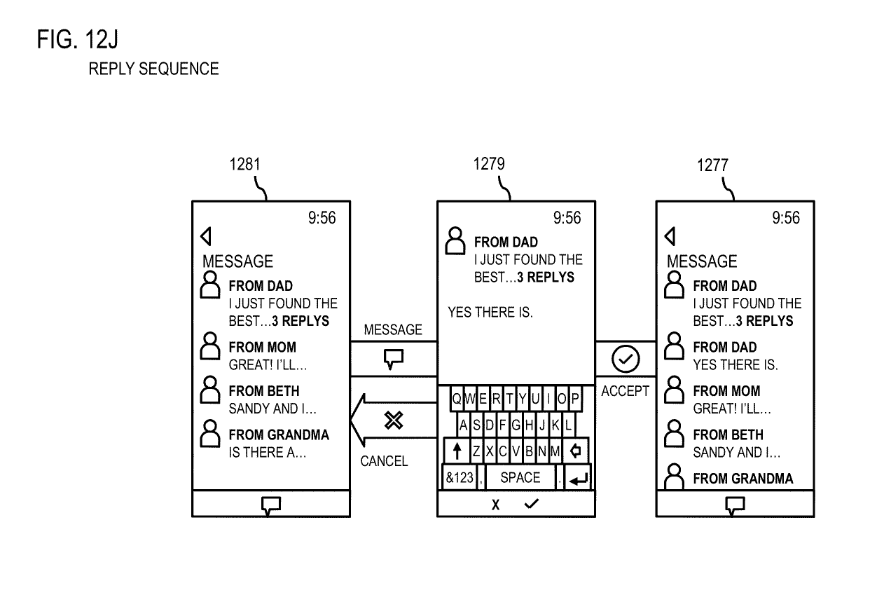

FIGS. 12A-12J are diagrams of user interfaces utilized in the processes of FIGS. 5-8, according to various embodiments. In this example, the user equipment is a ubiquitous device equipped with a graphical user interface. In particular, the user interface is intended to depict to the user of the smartphone any activities that occur in a user group network session, wherein he/she is a member. In this example, for the purpose of understanding ‘apps’ may refer to a user group network session.

FIG. 12A is a diagram of a user interface operable within UE 101 depicting a process for a non-member joining or creating a user group network session. As such, the user may use his mobile device to access or create a user group network session. The user interface 1201 and 1203 represents the start screen of a mobile device, the user may tap on the ‘apps’ wherein a splash screen may be displayed (user interface 1205) followed by a display of ‘terms and conditions’ (user interface 1206). Upon accepting the terms and condition, the user may either join the user group network session or create a new user group network session and invite other to join.

FIG. 12B is a diagram of a user interface operable within UE 101 depicting a process for a previously joined member trying to ‘log-in’ the user group network session. The user interface 1209 and 1211 represents the start screen of a mobile device, the user may tap on the ‘apps’ wherein a splash screen may be displayed (user interface 1213), followed by the panorama message page (user interface 1215) which the user may use right away.

FIG. 12C is a diagram of a user interface operable within UE 101 depicting a process for creating a new user group network session. The user interface 1209 and 1211 represents the start screen of a mobile device wherein the user may be prompted whether he/she wants to join an existing online user group network session with people nearby or create a new user group network session and invite others to join. The user may choose to create a new user group network session wherein he/she may be prompted to give the user group network session a ‘name’ which is thereby displayed to prospective members when they attempt to join the user group network session (user interface 1219). Then, the user may be directed to ‘success page’ wherein the user may monitor the growth of his/her user group network session. The user may be prompted when any member joins in the user group network session (user interface 1221). Subsequently, the user may be prompted to create a profile (user interface 1223), this step is skipped if the user already has a profile. The user then may proceed with the user group network session, as illustrated in user interface 1225, the organizer of the user group network session has joined and is awaiting other members to join.

FIG. 12D is a diagram of a user interface operable within UE 101 depicting a process for ending a user group network session by the organizer. The user interface 1227 represents the start screen of a mobile device wherein the user may be prompted with an option to end the user group network session, wherein all other members may get a message that the user group online session has ended and all the data from the user group network session is going to be deleted. Upon termination of the user group network session the user may be informed about the same (user interface 1229). The user may be further prompted with an option to join another existing user group network session with people nearby and/or create a new user group network session and invite other to join (user interface 1231). In one scenario, the user may define the size of nearby in the context of a game or any other activity that may require boundaries.

FIG. 12E is a diagram of a user interface operable within UE 101 depicting a different process for joining the user group network session. In one scenario, a user may join an existing online user group network session with people nearby by tapping the first UE 101a and the second UE 101n together to initiate a NFC link between the two UEs 101 (user interface 1235). In one scenario, a user may join an existing online user group network session though invitation, wherein people who have joined the user group network session may send an invite (user interface 1237). Subsequently, the user may be prompted to create a profile (user interface 1239), this step is skipped if the user already has a profile. The user then may proceed with the user group network session, as illustrated in user interface 1241, and share information of interest with other members.

FIG. 12F is a diagram of a user interface operable within UE 101 depicting a process for adding member to the user group network session. In one scenario, a user may join by tapping a UE 101 with a member UE 101 to join a pre-existing user group network session (user interface 1243 and 1247). In one scenario, a member may invite a user by sending an email invitation (user interface 1245). Subsequently, the user may proceed with the user group network session, as illustrated in user interface 1249, and discuss with other members.

FIGS. 12G and 12H are diagrams of a user interface operable within UE 101 depicting a panorama for sharing of messages, people, places and photos. In one scenario, a user may be prompted of a new message (user interface 1251) and the user may view the new message and other message flow by tapping the message (user interface 1261). Likewise, in one scenario, a user may tap on the profile name of a member (user interface 1253) wherein the user may be presented with the profile updates of that member (user interface 1263). In the same way, in one scenario, a user may tap on the place (user interface 1257) wherein the user may be presented with places shared by other members' (user interface 1265). Similarly, in one scenario, a user may simply tap on the pictures taken by another member (user interface 1257) to view the picture in an augmented reality display (user interface 1267). Subsequently, the setting page (user interface 1259 and 1269) can appear as a part of the panorama or may be accessed from the ‘apps’ bar overflow.

FIG. 121 is a diagram of a user interface operable within UE 101 depicting a sequence for new messages. In one scenario, a member may send a message, which may be displayed on UE 101 of the user (user interface 1271). The user may accept the message, wherein the full message can be displayed to the user (user interface 1273). Subsequently, the new event may be displayed along with other current events (user interface 1275).

FIG. 12J is a diagram of a user interface operable within UE 101 depicting a reply sequence for new messages. In one scenario, a member may send a message, which may be displayed on UE 101 of the user (user interface 1277). The recipient user may reply to the message (user interface 1279) wherein the response may be displayed with other response received for the original message and may be displayed as a thread (user interface 1281).

The processes described herein for causing a formation of at least one user group network session by a first device, and granting access to the at least one second device upon determining location information between the first device and the at least one second device based, at least in part, on physical proximity, a near field communication, a wireless network, or a combination thereof, may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

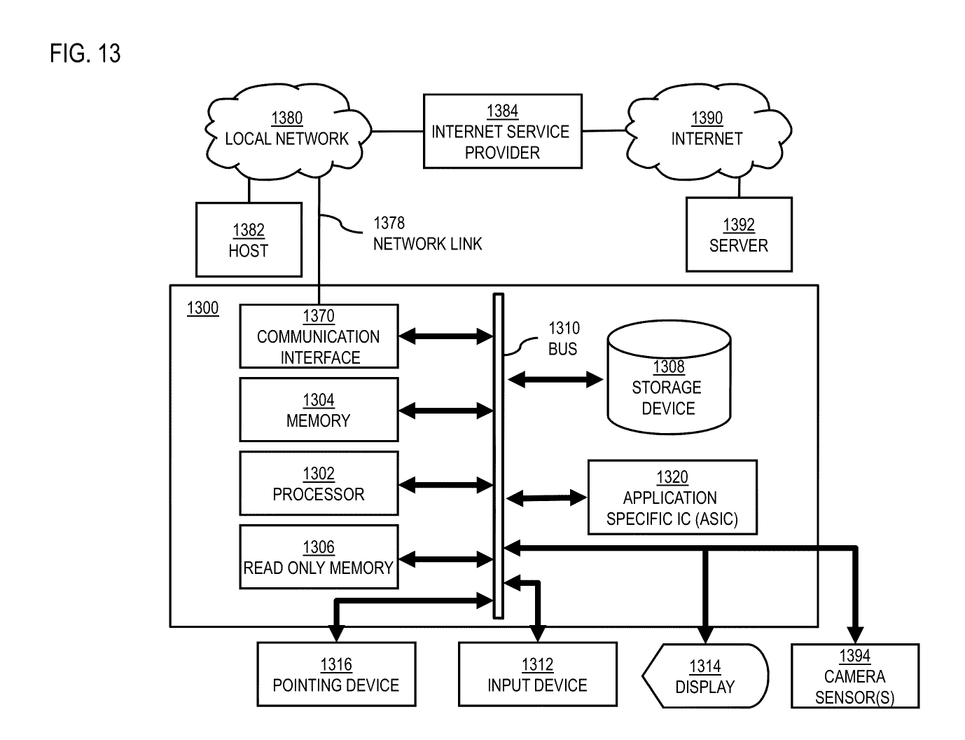

FIG. 13 illustrates a computer system 1300 upon which an embodiment of the invention may be implemented. Although computer system 1300 is depicted with respect to a particular device or equipment, it is contemplated that other devices or equipment (e.g., network elements, servers, etc.) within FIG. 13 can deploy the illustrated hardware and components of system 1300. Computer system 1300 is programmed (e.g., via computer program code or instructions) to cause a formation of at least one user group network session by a first device, and granting access to the at least one second device upon determining location information between the first device and the at least one second device based, at least in part, on physical proximity, a near field communication, a wireless network, or a combination thereof, as described herein and includes a communication mechanism such as a bus 1310 for passing information between other internal and external components of the computer system 1300. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1300, or a portion thereof, constitutes a means for performing one or more steps of causing a formation of at least one user group network session by a first device, and granting access to the at least one second device upon determining location information between the first device and the at least one second device based, at least in part, on physical proximity, a near field communication, a wireless network, or a combination thereof.

A bus 1310 includes one or more parallel conductors of information so that information is transferred quickly among devices coupled to the bus 1310. One or more processors 1302 for processing information are coupled with the bus 1310.

A processor (or multiple processors) 1302 performs a set of operations on information as specified by computer program code related to cause a formation of at least one user group network session by a first device, and granting access to the at least one second device upon determining location information between the first device and the at least one second device based, at least in part, on physical proximity, a near field communication, a wireless network, or a combination thereof. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1310 and placing information on the bus 1310. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1302, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1300 also includes a memory 1304 coupled to bus 1310. The memory 1304, such as a random access memory (RAM) or any other dynamic storage device, stores information including processor instructions for causing a formation of at least one user group network session by a first device, and granting access to the at least one second device upon determining location information between the first device and the at least one second device based, at least in part, on physical proximity, a near field communication, a wireless network, or a combination thereof. Dynamic memory allows information stored therein to be changed by the computer system 1300. RAM allows a unit of information stored at a location called a memory address to be stored and retrieved independently of information at neighboring addresses. The memory 1304 is also used by the processor 1302 to store temporary values during execution of processor instructions. The computer system 1300 also includes a read only memory (ROM) 1306 or any other static storage device coupled to the bus 1310 for storing static information, including instructions, that is not changed by the computer system 1300. Some memory is composed of volatile storage that loses the information stored thereon when power is lost. Also coupled to bus 1310 is a non-volatile (persistent) storage device 1308, such as a magnetic disk, optical disk or flash card, for storing information, including instructions, that persists even when the computer system 1300 is turned off or otherwise loses power.

Information, including instructions for causing a formation of at least one user group network session by a first device, and granting access to the at least one second device upon determining location information between the first device and the at least one second device based, at least in part, on physical proximity, a near field communication, a wireless network, or a combination thereof, is provided to the bus 1310 for use by the processor from an external input device 1312, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1300. Other external devices coupled to bus 1310, used primarily for interacting with humans, include a display device 1314, such as a cathode ray tube (CRT), a liquid crystal display (LCD), a light emitting diode (LED) display, an organic LED (OLED) display, a plasma screen, or a printer for presenting text or images, and a pointing device 1316, such as a mouse, a trackball, cursor direction keys, or a motion sensor, for controlling a position of a small cursor image presented on the display 1314 and issuing commands associated with graphical elements presented on the display 1314, and one or more camera sensors 1394 for capturing, recording and causing to store one or more still and/or moving images (e.g., videos, movies, etc.) which also may comprise audio recordings. In some embodiments, for example, in embodiments in which the computer system 1300 performs all functions automatically without human input, one or more of external input device 1312, display device 1314 and pointing device 1316 is may be omitted.

In the illustrated embodiment, special purpose hardware, such as an application specific integrated circuit (ASIC) 1320, is coupled to bus 1310. The special purpose hardware is configured to perform operations not performed by processor 1302 quickly enough for special purposes. Examples of ASICs include graphics accelerator cards for generating images for display 1314, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1300 also includes one or more instances of a communications interface 1370 coupled to bus 1310. Communication interface 1370 provides a one-way or two-way communication coupling to a variety of external devices that operate with their own processors, such as printers, scanners and external disks. In general the coupling is with a network link 1378 that is connected to a local network 1380 to which a variety of external devices with their own processors are connected. For example, communication interface 1370 may be a parallel port or a serial port or a universal serial bus (USB) port on a personal computer. In some embodiments, communications interface 1370 is an integrated services digital network (ISDN) card or a digital subscriber line (DSL) card or a telephone modem that provides an information communication connection to a corresponding type of telephone line. In some embodiments, a communication interface 1370 is a cable modem that converts signals on bus 1310 into signals for a communication connection over a coaxial cable or into optical signals for a communication connection over a fiber optic cable. As another example, communications interface 1370 may be a local area network (LAN) card to provide a data communication connection to a compatible LAN, such as Ethernet. Wireless links may also be implemented. For wireless links, the communications interface 1370 sends or receives or both sends and receives electrical, acoustic or electromagnetic signals, including infrared and optical signals, that carry information streams, such as digital data. For example, in wireless handheld devices, such as mobile telephones like cell phones, the communications interface 1370 includes a radio band electromagnetic transmitter and receiver called a radio transceiver. In certain embodiments, the communications interface 1370 enables connection to the communication network 109 for causing a formation of at least one user group network session by a first device, and granting access to the at least one second device upon determining location information between the first device and the at least one second device based, at least in part, on physical proximity, a near field communication, a wireless network, or a combination thereof, to the UE 101.

The term “computer-readable medium” as used herein refers to any medium that participates in providing information to processor 1302, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1308. Volatile media include, for example, dynamic memory 1304. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1320.

Network link 1378 typically provides information communication using transmission media through one or more networks to other devices that use or process the information. For example, network link 1378 may provide a connection through local network 1380 to a host computer 1382 or to equipment 1384 operated by an Internet Service Provider (ISP). ISP equipment 1384 in turn provides data communication services through the public, world-wide packet-switching communication network of networks now commonly referred to as the Internet 1390.

A computer called a server host 1392 connected to the Internet hosts a process that provides a service in response to information received over the Internet. For example, server host 1392 hosts a process that provides information representing video data for presentation at display 1314. It is contemplated that the components of system 1300 can be deployed in various configurations within other computer systems, e.g., host 1382 and server 1392.

At least some embodiments of the invention are related to the use of computer system 1300 for implementing some or all of the techniques described herein. According to one embodiment of the invention, those techniques are performed by computer system 1300 in response to processor 1302 executing one or more sequences of one or more processor instructions contained in memory 1304. Such instructions, also called computer instructions, software and program code, may be read into memory 1304 from another computer-readable medium such as storage device 1308 or network link 1378. Execution of the sequences of instructions contained in memory 1304 causes processor 1302 to perform one or more of the method steps described herein. In alternative embodiments, hardware, such as ASIC 1320, may be used in place of or in combination with software to implement the invention. Thus, embodiments of the invention are not limited to any specific combination of hardware and software, unless otherwise explicitly stated herein.

The signals transmitted over network link 1378 and other networks through communications interface 1370, carry information to and from computer system 1300. Computer system 1300 can send and receive information, including program code, through the networks 1380, 1390 among others, through network link 1378 and communications interface 1370. In an example using the Internet 1390, a server host 1392 transmits program code for a particular application, requested by a message sent from computer 1300, through Internet 1390, ISP equipment 1384, local network 1380 and communications interface 1370. The received code may be executed by processor 1302 as it is received, or may be stored in memory 1304 or in storage device 1308 or any other non-volatile storage for later execution, or both. In this manner, computer system 1300 may obtain application program code in the form of signals on a carrier wave.

Various forms of computer readable media may be involved in carrying one or more sequence of instructions or data or both to processor 1302 for execution. For example, instructions and data may initially be carried on a magnetic disk of a remote computer such as host 1382. The remote computer loads the instructions and data into its dynamic memory and sends the instructions and data over a telephone line using a modem. A modem local to the computer system 1300 receives the instructions and data on a telephone line and uses an infra-red transmitter to convert the instructions and data to a signal on an infra-red carrier wave serving as the network link 1378. An infrared detector serving as communications interface 1370 receives the instructions and data carried in the infrared signal and places information representing the instructions and data onto bus 1310. Bus 1310 carries the information to memory 1304 from which processor 1302 retrieves and executes the instructions using some of the data sent with the instructions. The instructions and data received in memory 1304 may optionally be stored on storage device 1308, either before or after execution by the processor 1302.

FIG. 14 illustrates a chip set or chip 1400 upon which an embodiment of the invention may be implemented. Chip set 1400 is programmed to cause a formation of at least one user group network session by a first device, and granting access to the at least one second device upon determining location information between the first device and the at least one second device based, at least in part, on physical proximity, a near field communication, a wireless network, or a combination thereof, as described herein and includes, for instance, the processor and memory components described with respect to FIG. 13 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1400 can be implemented in a single chip. It is further contemplated that in certain embodiments the chip set or chip 1400 can be implemented as a single “system on a chip.” It is further contemplated that in certain embodiments a separate ASIC would not be used, for example, and that all relevant functions as disclosed herein would be performed by a processor or processors. Chip set or chip 1400, or a portion thereof, constitutes a means for performing one or more steps of providing user interface navigation information associated with the availability of functions. Chip set or chip 1400, or a portion thereof, constitutes a means for performing one or more steps of causing a formation of at least one user group network session by a first device, and granting access to the at least one second device upon determining location information between the first device and the at least one second device based, at least in part, on physical proximity, a near field communication, a wireless network, or a combination thereof.

In one embodiment, the chip set or chip 1400 includes a communication mechanism such as a bus 1401 for passing information among the components of the chip set 1400. A processor 1403 has connectivity to the bus 1401 to execute instructions and process information stored in, for example, a memory 1405. The processor 1403 may include one or more processing cores with each core configured to perform independently. A multi-core processor enables multiprocessing within a single physical package. Examples of a multi-core processor include two, four, eight, or greater numbers of processing cores. Alternatively or in addition, the processor 1403 may include one or more microprocessors configured in tandem via the bus 1401 to enable independent execution of instructions, pipelining, and multithreading. The processor 1403 may also be accompanied with one or more specialized components to perform certain processing functions and tasks such as one or more digital signal processors (DSP) 1407, or one or more application-specific integrated circuits (ASIC) 1409. A DSP 1407 typically is configured to process real-world signals (e.g., sound) in real time independently of the processor 1403. Similarly, an ASIC 1409 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1400 includes merely one or more processors and some software and/or firmware supporting and/or relating to and/or for the one or more processors.

The processor 1403 and accompanying components have connectivity to the memory 1405 via the bus 1401. The memory 1405 includes both dynamic memory (e.g., RAM, magnetic disk, writable optical disk, etc.) and static memory (e.g., ROM, CD-ROM, etc.) for storing executable instructions that when executed perform the inventive steps described herein to cause a formation of at least one user group network session by a first device, and granting access to the at least one second device upon determining location information between the first device and the at least one second device based, at least in part, on physical proximity, a near field communication, a wireless network, or a combination thereof. The memory 1405 also stores the data associated with or generated by the execution of the inventive steps.

FIG. 15 is a diagram of exemplary components of a mobile terminal (e.g., handset) for communications, which is capable of operating in the system of FIG. 1, according to one embodiment. In some embodiments, mobile terminal 1501, or a portion thereof, constitutes a means for performing one or more steps of causing a formation of at least one user group network session by a first device, and granting access to the at least one second device upon determining location information between the first device and the at least one second device based, at least in part, on physical proximity, a near field communication, a wireless network, or a combination thereof. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1503, a Digital Signal Processor (DSP) 1505, and a receiver/transmitter unit including a microphone gain control unit and a speaker gain control unit. A main display unit 1507 provides a display to the user in support of various applications and mobile terminal functions that perform or support the steps of causing a formation of at least one user group network session by a first device, and granting access to the at least one second device upon determining location information between the first device and the at least one second device based, at least in part, on physical proximity, a near field communication, a wireless network, or a combination thereof. The display 1507 includes display circuitry configured to display at least a portion of a user interface of the mobile terminal (e.g., mobile telephone). Additionally, the display 1507 and display circuitry are configured to facilitate user control of at least some functions of the mobile terminal. An audio function circuitry 1509 includes a microphone 1511 and microphone amplifier that amplifies the speech signal output from the microphone 1511. The amplified speech signal output from the microphone 1511 is fed to a coder/decoder (CODEC) 1513.

A radio section 1515 amplifies power and converts frequency in order to communicate with a base station, which is included in a mobile communication system, via antenna 1517. The power amplifier (PA) 1519 and the transmitter/modulation circuitry are operationally responsive to the MCU 1503, with an output from the PA 1519 coupled to the duplexer 1521 or circulator or antenna switch, as known in the art. The PA 1519 also couples to a battery interface and power control unit 1520.

In use, a user of mobile terminal 1501 speaks into the microphone 1511 and his or her voice along with any detected background noise is converted into an analog voltage. The analog voltage is then converted into a digital signal through the Analog to Digital Converter (ADC) 1523. The control unit 1503 routes the digital signal into the DSP 1505 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1525 for compensation of any frequency-dependent impairments that occur during transmission though the air such as phase and amplitude distortion. After equalizing the bit stream, the modulator 1527 combines the signal with a RF signal generated in the RF interface 1529. The modulator 1527 generates a sine wave by way of frequency or phase modulation. In order to prepare the signal for transmission, an up-converter 1531 combines the sine wave output from the modulator 1527 with another sine wave generated by a synthesizer 1533 to achieve the desired frequency of transmission. The signal is then sent through a PA 1519 to increase the signal to an appropriate power level. In practical systems, the PA 1519 acts as a variable gain amplifier whose gain is controlled by the DSP 1505 from information received from a network base station. The signal is then filtered within the duplexer 1521 and optionally sent to an antenna coupler 1535 to match impedances to provide maximum power transfer. Finally, the signal is transmitted via antenna 1517 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1501 are received via antenna 1517 and immediately amplified by a low noise amplifier (LNA) 1537. A down-converter 1539 lowers the carrier frequency while the demodulator 1541 strips away the RF leaving only a digital bit stream. The signal then goes through the equalizer 1525 and is processed by the DSP 1505. A Digital to Analog Converter (DAC) 1543 converts the signal and the resulting output is transmitted to the user through the speaker 1545, all under control of a Main Control Unit (MCU) 1503 which can be implemented as a Central Processing Unit (CPU).

The MCU 1503 receives various signals including input signals from the keyboard 1547. The keyboard 1547 and/or the MCU 1503 in combination with other user input components (e.g., the microphone 1511) comprise a user interface circuitry for managing user input. The MCU 1503 runs a user interface software to facilitate user control of at least some functions of the mobile terminal 1501 to cause a formation of at least one user group network session by a first device, and granting access to the at least one second device upon determining location information between the first device and the at least one second device based, at least in part, on physical proximity, a near field communication, a wireless network, or a combination thereof. The MCU 1503 also delivers a display command and a switch command to the display 1507 and to the speech output switching controller, respectively. Further, the MCU 1503 exchanges information with the DSP 1505 and can access an optionally incorporated SIM card 1549 and a memory 1551. In addition, the MCU 1503 executes various control functions required of the terminal. The DSP 1505 may, depending upon the implementation, perform any of a variety of conventional digital processing functions on the voice signals. Additionally, DSP 1505 determines the background noise level of the local environment from the signals detected by microphone 1511 and sets the gain of microphone 1511 to a level selected to compensate for the natural tendency of the user of the mobile terminal 1501.

The CODEC 1513 includes the ADC 1523 and DAC 1543. The memory 1551 stores various data including call incoming tone data and is capable of storing other data including music data received via, e.g., the global Internet. The software module could reside in RAM memory, flash memory, registers, or any other form of writable storage medium known in the art. The memory device 1551 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1549 carries, for instance, important information, such as the cellular phone number, the carrier supplying service, subscription details, and security information. The SIM card 1549 serves primarily to identify the mobile terminal 1501 on a radio network. The card 1549 also contains a memory for storing a personal telephone number registry, text messages, and user specific mobile terminal settings.

Further, one or more camera sensors 1553 may be incorporated onto the mobile station 1501 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a formation of at least one user group network session by a first device;
at least one determination of a request from at least one second device for an access to the at least one user group network session;
at least one determination of location information between the first device and the at least one second device based, at least in part, on physical proximity, a near field communication, a wireless network, or a combination thereof; and
a granting of the access to the at least one second device to the user group network session based, at least in part, on the location information.

2. A method of claim 1, wherein the (1) data and/or (2) information and/or (3) at least one signal are further based, at least in part, on the following:
a granting of the access to the at least one user group based, at least in part, on an invitation from the first device to the at least one second device.

3. A method of claim 1, wherein the (1) data and/or (2) information and/or (3) at least one signal are further based, at least in part, on the following:
a presentation of the user group network session in an augmented reality user interface.

4. A method of claim 1, wherein the (1) data and/or (2) information and/or (3) at least one signal are further based, at least in part, on the following:
a monitoring of the location information continuously, periodically, according to a schedule, on demand, or a combination thereof; and
at least one determination to maintain the access to the user group network session for the at least one user based, at least in part, on the monitoring.

5. A method of claim 1, wherein the (1) data and/or (2) information and/or (3) at least one signal are further based, at least in part, on the following:
a processing of contextual information associated with the first device, the at least one second device, or a combination thereof to cause, at least in part, a ranking of the at least one second devices based, at least in part, on a physical proximity, a social proximity, or a combination thereof to the first device; and
at least one determination of one or more weighting values for the at least one second devices based, at least in part, on the ranking.

6. A method of claim 5, wherein the contextual information includes, at least in part, user profile information, user preference information, location information, temporal information, activity information, or a combination.

7. A method of claim 1, wherein the (1) data and/or (2) information and/or (3) at least one signal are further based, at least in part, on the following:
a marking of one or more places, a broadcasting of the one or more places, or a combination thereof, by the first device, the at least one second device, or a combination thereof.

8. A method of claim 1, wherein the at least one second device may exit the at least one user group network session at any point after joining the session.

9. A method of claim 8, wherein the (1) data and/or (2) information and/or (3) at least one signal are further based, at least in part, on the following:
a presentation of an alert message based, at least in part, on determining that the at least one second device has exited the user group network session.

10. A method of claim 1, wherein the (1) data and/or (2) information and/or (3) at least one signal are further based, at least in part, on the following:
a termination of the at least one user group network session by the first device any time after the creation of the at least one user group network session.

11. An apparatus comprising:
at least one processor; and
at least one memory including computer program code for one or more programs,
the at least one memory and the computer program code configured to, with the at least one processor, cause the apparatus to perform at least the following,
cause, at least in part, a formation of at least one user group network session by a first device;
determine a request from at least one second device for an access to the at least one user group network session;
determine location information between the first device and the at least one second device based, at least in part, on physical proximity, a near field communication, a wireless network, or a combination thereof; and
cause, at least in part, a granting of the access to the at least one second device to the user group network session based, at least in part, on the location information.

12. An apparatus of claim 11, wherein the apparatus is further caused to:
cause, at least in part, a granting of the access to the at least one user group based, at least in part, on an invitation from the first device to the at least one second device.

13. An apparatus of claim 11, wherein the apparatus is further caused to:
cause, at least in part, a presentation of the user group network session in an augmented reality user interface.

14. An apparatus of claim 11, wherein the apparatus is further caused to:
cause, at least in part, a monitoring of the location information continuously, periodically, according to a schedule, on demand, or a combination thereof; and
determine to maintain the access to the user group network session for the at least one user based, at least in part, on the monitoring.

15. An apparatus of claim 11, wherein the apparatus is further caused to:
process and/or facilitate a processing of contextual information associated with the first device, the at least one second device, or a combination thereof to cause, at least in part, a ranking of the at least one second devices based, at least in part, on a physical proximity, a social proximity, or a combination thereof to the first device; and
determine one or more weighting values for the at least one second devices based, at least in part, on the ranking.

16. An apparatus of claim 15, wherein the contextual information includes, at least in part, user profile information, user preference information, location information, temporal information, activity information, or a combination.

17. An apparatus of claim 11, wherein the apparatus is further caused to:
cause, at least in part, a marking of one or more places, a broadcasting of the one or more places, or a combination thereof, by the first device, the at least one second device, or a combination thereof.

18. An apparatus of claim 11, wherein the at least one second device may exit the at least one user group network session at any point after joining the session.

19. An apparatus of claim 18, wherein the apparatus is further caused to:
cause, at least in part, a presentation of an alert message based, at least in part, on determining that the at least one second device has exited the user group network session.

20. An apparatus of claim 11, wherein the apparatus is further caused to:
cause, at least in part, a termination of the at least one user group network session by the first device any time after the creation of the at least one user group network session.

21.-48. (canceled)
